(19) United States
(12) Patent Application Publication
(10) Pub. No.: US 2006/0290772 A1
(43) Pub. Date: Dec. 28, 2006

(54) Method of manufacturing rapid prototyping workpiece by using laser transfer printing technology

(76) Inventors: Sheng-Jye Hwang, Tainan City (TW); Sen-Yung Lee, Tainan City (TW); Wei-Hsian Lai, Tainan City (TW); Chun-I Cheng, Jiading Township (TW); Muh-Rong Wang, Tainan City (TW); Chun-Shan Wang, Tainan City (TW); Chuh-Yung Chen, Tainan City (TW); Chieh-Li Chen, Tainan City (TW); Chen Hsieh, Tainan City (TW); Cheng-Chien Wang, Rende Township (TW); Tzong-Shyng Leu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/159,194

(22) Filed: Jun. 23, 2005

(51) Int. Cl. B41J 2/435

(52) U.S. Cl. 347/224

(57) ABSTRACT

The invention discloses a method of manufacturing rapid prototyping workpiece by projecting a laser beam or other light onto the photo-conductive drum to attach powder materials to form a thin layer, and then coat the thin-layer material on a working platform. A point, line or plane light source of stronger intensity is used to go with the DMD (Digital Micromirror Device) or LCD (Liquid Crystal Display) to produce a physical change or a chemical change in the selected projecting region and combine the materials to become an acceptable property. The method comprises three stages of a process and repeats the process to complete a physical workpiece. The first stage refers to evenly spreading electric charges on a photo-conductive drum, and then projects a laser beam or a visible light onto the photo-conductive drum to electically conduct the electric charges and lower the electric potiential. By that time, the photo-conductive drum rotated in a high speed passes through a cartridge containing powder, the material will be attached onto the photo-conductive drum, since there is a potential difference between the photo-conductive drum and the material. Then, an appropriate method is used to flatly coat the material disposed on the photo-conductive drum onto the working platform, and thus a very thin even material layer is formed. The second stage refers to using a point, line or plane light source of stronger intensity for a selected region to go with a DMD or LCD to project or scan the selected region and produce a physical or chemical change, so that the materials are combined with each other to form an acceptable property. The third stage refers to removing the material remained on the photo-conductive drum and eliminating the static charges on the photo-conductive drum, so that the electric potential at the surface of the photo-conductive drum resumes its initial state to facilitate the next loop of actions. The whole manufacturing process uses this method to stack layer by layer to build a complete three-dimensional physical workpiece, so as to achieve the effect of saving work hours, materials and costs as well as enhancing the precision of the workpiece. The invention is definitely a very valuable manufacturing method.

### BACKGROUND OF THE INVENTION

1. Field of the Invention

The present invention generally relates to a method of manufacturing rapid prototyping workpiece, and more particularly to a manufacturing process that uses the static electricity of a photo-conductive drum as the driving force and applies such to rapidly manufacture a three-dimensional physical workpiece. The process starts with charging the photo-conductive drum fully, and then projects a laser beam or a visible light on the photo-conductive drum to electrically conduct its electric charges and lower the electric potential. The photo-conductive drum is rotated in a high speed and powders will be attached onto the photo-conductive drum when it passes through a material cartridge, and then an appropriate method is used to evenly transfer print and attach the material of the photo-conductive drum onto a working platform. A light source with strong intensity is used for the regions selected by the system, and a DMD or LCD can be used together to illuminate the selected region and produce a physical or chemical change, such that the materials can be combined with each other into an acceptable property. Finally, the materials remained on the photo-conductive drum are removed and the static charges on the photo-conductive drum are eliminated, so that the electric potential at the surface of the photo-conductive drum resumes its initial state in order to start the next loop of actions. The entire manufacturing process uses this method for a layer-by-layer stack to build a complete three-dimensional physical workpiece.

2. Description of the Related Art

A complete product development flow includes the stages of design, trial, manufacturing process plan, mass production and product launch, etc. In the product development process, a sample or prototype is usually required for evaluations and verifications to avoid a wrong design or market trend after investing tremendous capital and efforts. Different products require a total solution of a product design and trail run to cope with the changes of a design, the rapid prototyping and the low cost and meet the requirements of diversified features and functions.

The prototyping can be divided into many different ways, including the traditional handmade prototyping, CNC, carving by a milling or carving machine, or recently developed rapid prototyping. However, traditional handmade mold requires experienced technicians and is not as precise, and CNC carving also has limitations on the molding, clamping tools and knife tools. The new-generation rapid prototyping system based on layer manufacturing can achieve a rapid, fully automatic prototyping without the limitation on the molding.

As the times advance, computer aided design (CAD) software is developed rapidly, so that the life cycle of a new product is greatly shortened. In the past years, rapid prototyping has integrated CAD and manufacturing technologies, and thus further enhance the efficiency on designing products. Rapid prototyping could be called layer manufacturing, automated fabrication, freeform fabrication, or solid imaging, etc. After the development of more than a decade in the past, there are over ten RP models in the market, and rapid prototyping manufacturing method is divided into light projection formation method, adhesion formation method and complex formation method according to the different energy source used. According to related literatures, rapid prototyping process is divided into different classes according to the workpiece material, energy used, and adhesion method. FIG. 1 shows several common manufacture processes:

1. SLA is the most extensively used manufacturing process in the world, and its formation method adopts stereolithography for the formation, and the process uses He—Cd or Ar+ultraviolet laser and a galvanometer-mirror scan to project liquid polymers (curing adhesive resin) onto the desired formation position to produce a thin layer (approximately 0.15 ˜mm0.05 mm) of hardened resin, and then the Z-axis machine descend to cover the desired workpiece with a layer of liquid polymer. A scraper is used to destroy the surface tension as to level the liquid surface or fill in the vacuum. Then, a laser beam is used for the scan to tightly bind this layer with the previous layer. By repeating the above procedure, a complete 3D physical workpiece is produced. The SLA method is illustrated in FIG. 2.

For this SLA related invention, American 3D Systems Company had filed a patent application on Aug. 8, 1984 and the application was granted on Mar. 11, 1986, and such patented technology dominates a vast majority of the world market.

However, the SLA method still has the following issues:

a. It needs to build supports.

b. Since its material is a liquid resin and it is necessary to prepare buckets to fill up with the materials for making the workpiece, therefore it requires more materials and incurs a higher cost.

2. SLS: A high-power laser is used to sinter a polymer resin powder. The resin dissolved by heat is adhered to the original powder of the workpiece to form a desired thin layer cross section of the formed workpiece, and the Z-axis machine descends, and a scraper coats a layer of powder onto the working platform again. Laser is used again to sinter the desired cross section. The above procedure is repeated until a complete 3D physical workpiece is produced. The SLS method is illustrated in FIG. 3.

The SLS method still has the following issues:

a. Roller or scraper is used to coat powder, and thus the density of powder will be uneven.

b. The powder requires a preheat time and thus extending the manufacturing time.

c. Powder causes dusts easily, which is harmful to human body.

d. Powder is hard to be heated evenly.

e. This manufacturing process cannot be applied easily for large workpiece.

3. FDM: The workpiece powder is premixed with adhesives to produce a long linear bar and dissolved by heat for feeding the material through a nozzle. The major drawback of this method resides on a poor surface coarseness and its need of building supports. FIG. 4 shows a drawing related to the structure and principle of FDM.

4. 3DP: It is also known as three-dimensional printing and this method builds a thin layer of powder first and uses an ink-jet technology to selectively spray adhesives onto the powdered surface, such that the powders are attached to form a thin-layer cross section of the physical workpiece. The foregoing procedure is repeated until the three-dimensional physical workpiece is produced. The 3DP method still has the following issues:

a. Since the formation is completely controlled by using a nozzle, and thus the precision requirement of the nozzle is extremely high.

b. It has a poor precision.

c. It can only use a material with many gaps as a substrate of the workspace.

d. It is not easy to spread the powder with an even density.

The 3DP method is illustrated in FIG. 5.

5. LOM: The solidified thin-layer material is cut by laser into thin-layer cross section of the physical workpiece, and an adhesive is used to connect and stack layer by layer. The molecules of the material used in this method are linked with each other, and it is necessary to prepare each layer material before the manufacture, and thus the preparation is more complicated. Furthermore, the major drawback of this manufacturing process resides on the difficulty of obtaining additional material.

6. OBJet: OBJet is also a three-dimensional printing, and OBJet uses two different types of materials: a substrate for producing the three-dimensional physical workpiece and a support for the mold formation. If a formation is performed by the OBJet method, a nozzle is used to spray two different types of materials, and a very thin layer is formed. Then, ultraviolet is projected to cook the workpiece, and the strength of the workpiece is enhanced after the substrate of the workpiece is cooked by the projection of ultraviolet. The support material is also changed into a plastic-like form. The foregoing process is repeated until the three-dimensional physical workpiece is produced.

The OBJet process has features the high quality, high precision, clean and rapid advantages, but the most important component for the process is the nozzle. The quality of finished goods is controlled by the nozzle. If the nozzle is not controlled properly, then the precision of the finished goods will become low. However, the cost for a high-precision nozzle is very high, and such nozzle gets clogged very easily, and thus greatly increasing the cost.

7. Traditional DLP: DLP is also a stereolithography process and differs from the SLA that the SLA uses laser to harden the resin. Since laser comes with slender straight lines, therefore the whole manufacturing process will be extended. Using laser as an activation source incurs a higher cost, and the DLP uses the light emitted from halides and the DMD (Digital Micromirror Device) controls whether or not to project the light onto the curing adhesive resin. Since the light source used by the DLP process can be projected onto a region at the same time, therefore the manufacturing time can be reduced greatly, and the precision of the DLP process can be controlled by the DMD devices. The present resolution can reach up to 1280*1024, and the tolerance is dropped to plus and minus 0.005 inch.

The DLP process only uses one material, and the material will be hardened by light projection during the prototyping by DLP. By then, the working platform ascends, and a layer of unhardened material is covered onto the hardened material. This process is repeated until the three-dimensional physical workpiece is produced. The DLP still has the following issues:
1. Since the prepared material is a liquid resin and it requires buckets to fill up the material for manufacturing the workpiece, therefore it requires more materials and a higher cost for the manufacturing.
2. The precision is completely controlled by the DMD, and thus the precision of the DMD is extremely high and directly affects the manufacturing cost.
3. Light is uses as the activation source, and thus the isolation of light is very important. The low-density light source provided by DMD is easily affected by the light in the environment, and thus material stored in a large bucket may be deteriorated easily, which makes the storage of raw material very easy.
4. It is necessary to build additional support of producing some workpieces.
5. Since the projecting area is larger and the intensity of the light source is insufficient, the substrate is not reacted completely and its strength will not be strong enough.

The DLP process is illustrated in FIGS. 6 to 8.

In addition to the foregoing seven techniques, two new RP technologies will be introduced below. One of the two RP technologies was the rapid prototyping method disclosed by Hwahsing Tang in 2001, and this method specially uses a three-dimensional ceramic workpiece. Firstly, an inorganic binder and a dissolving agent are added into ceramic powder, and these materials will form a plastic mixture, and then this mixture is placed flatly to form a thin layer. The mixture is heated to a dry and hardened state. The hardening is caused by the reduction of moisture in the inorganic binder to increase its density and enhance the binding. However, it has a weak strength similar to a ceramic sintered by dry mud. A laser beam is used to sinter the selected region so as to harden it for the second time. The hardening is caused by the ceramic powder being not sintered but combined. Its strength is much stronger than the section hardened by dehydration only. Therefore, the inventor of the present invention can select an appropriate method to separate the two materials of different hardness. However, this kind of manufacturing process mainly uses ceramic mud technology for manufacturing ceramic workpieces, but it is not applicable for a general rapid prototyping workpiece.

Another RP technology is a patented invention disclosed by Dr. Ashok V. Kuman of University of Miami, and its principle adopts a laser transfer printing method to manufacture three-dimensional physical workpiece. Unlike the present invention, such technology produces a cross section of the workpiece by fully relying on the projection of laser beam in the transfer printing section of the photo-conductive drum. The present invention simply uses the laser transfer printing technology to coat a thin layer of material, and uses an optical device such as an LCD or DMD to produce a point, line or plane light source. The light exposure technology is used or other material is added to produce an appropriate physical or chemical change to the workpiece. Therefore, the present invention is very different from the patent disclosed by Dr. Ashok V. Kuman.

### SUMMARY OF THE INVENTION

It is a primary objective of the present invention to provide a method of manufacturing rapid prototyping workpiece, characterized in that a laser beam or other light is projected onto the photo-conductive drum to attach powder materials to form a thin layer, and then the thin-layer material is coated on a working platform. A point, line or plane light source of stronger intensity is used to go with go with the DMD (Digital Micromirror Device) or LCD (Liquid Crystal Display) to scan or project the point, line or plane light source for a selective exposure and produce a physical change or a chemical change in the selected projecting region and combine the materials to become an acceptable property. The method comprises three stages of a process and repeats the process to complete a physical workpiece.

The first stage refers to evenly spreading electric charges on a photo-conductive drum, and then projects a laser beam or a visible light onto the photo-conductive drum to electically conduct the electric charges and lower the electric potiential. By that time, the photo-conductive drum rotated in a high speed passes through a cartridge containing powder, and the material will be attached onto the photo-conductive drum, since there is a potential difference between the photo-conductive drum and the material. Then, an appropriate method is used to flatly coat the material disposed on the photo-conductive drum onto the working platform, and thus a very thin even material layer is formed.

The second stage refers to using a point, line or plane light source of stronger intensity for a selected region to go with a DMD or LCD to project or scan the selected region and produce a physical or chemical change, so that the materials are combined with each other to form an acceptable property.

The third stage refers to removing the material remained on the photo-conductive drum and eliminating the static charges on the photo-conductive drum, so that the electric potential at the surface of the photo-conductive drum resumes its initial state to facilitate the next loop of actions.

The whole manufacturing process uses this method to stack layer by layer to build a complete three-dimensional physical workpiece, so as to achieve the effect of saving work hours, materials and costs as well as enhancing the precision of the workpiece. The invention is definitely a very valuable manufacturing method.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view of a rapid prototyping classification;

FIG. 2 is a schematic view of a SLA manufacturing method;

FIG. 3 is a schematic view of a SLS manufacturing method;

FIG. 4 is a schematic view of a FDM manufacturing method;

FIG. 5 is a schematic view of a 3DP manufacturing method;

FIG. 6 is a schematic view of the Type 1 of a DLP manufacturing method;

FIG. 7 is a schematic view of the Type 2 of a DLP manufacturing method;

FIG. 8 is a schematic view of the Type 3 of a DLP manufacturing method;

FIG. 9 is a flow chart of manufacturing a rapid prototyping workpiece according to the present invention;

FIG. 10 is a schematic view of a rapid prototyping workpiece according to a first preferred embodiment of the present invention;

FIG. 11 is a schematic view of a rapid prototyping workpiece according to a second preferred embodiment of the present invention;

FIG. 12 is a schematic view of a rapid prototyping workpiece according to a third preferred embodiment of the present invention;

FIG. 13 is a schematic view of a rapid prototyping workpiece according to a fourth preferred embodiment of the present invention;

FIG. 14 is a schematic view of a rapid prototyping workpiece according to a fifth preferred embodiment of the present invention;

FIG. 15 is a schematic view of a rapid prototyping workpiece according to a sixth preferred embodiment of the present invention;

FIG. 16 is a schematic view of a rapid prototyping workpiece according to a seventh preferred embodiment of the present invention;

FIG. 17 is a schematic view of a rapid prototyping workpiece according to an eighth preferred embodiment of the present invention;

FIG. 18 is a schematic view of a rapid prototyping workpiece according to a ninth preferred embodiment of the present invention;

FIG. 19 is a schematic view of a rapid prototyping workpiece according to a tenth preferred embodiment of the present invention;

FIG. 20 is a schematic view of a rapid prototyping workpiece according to an eleventh preferred embodiment of the present invention;

FIG. 21 is a schematic view of a rapid prototyping workpiece according to a twelfth first preferred embodiment of the present invention;

FIG. 22 is a schematic view of a rapid prototyping workpiece according to a thirteenth preferred embodiment of the present invention;

FIG. 23 is a schematic view of a rapid prototyping workpiece according to a fourteenth first preferred embodiment of the present invention;

FIG. 24 is a schematic view of a rapid prototyping workpiece according to a fifteenth preferred embodiment of the present invention;

FIG. 25 is a schematic view of a rapid prototyping workpiece according to a sixteenth preferred embodiment of the present invention;

FIG. 26 is a schematic view of a rapid prototyping workpiece according to an seventeenth preferred embodiment of the present invention;

FIG. 27 is a schematic view of a rapid prototyping workpiece according to a eighteenth preferred embodiment of the present invention;

FIG. 28 is a schematic view of a rapid prototyping workpiece according to a nineteenth preferred embodiment of the present invention;

FIG. 29 is a schematic view of a rapid prototyping workpiece according to a twentieth preferred embodiment of the present invention.

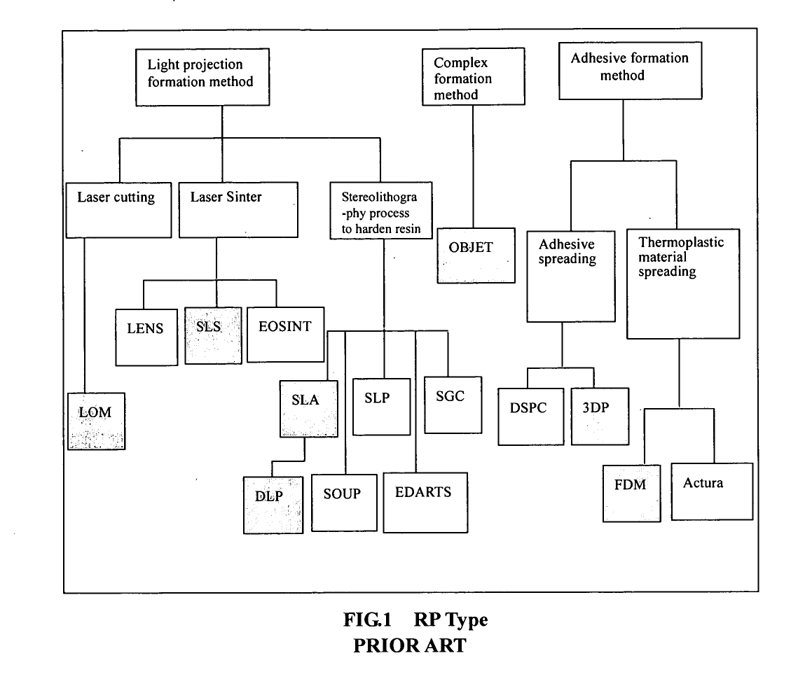

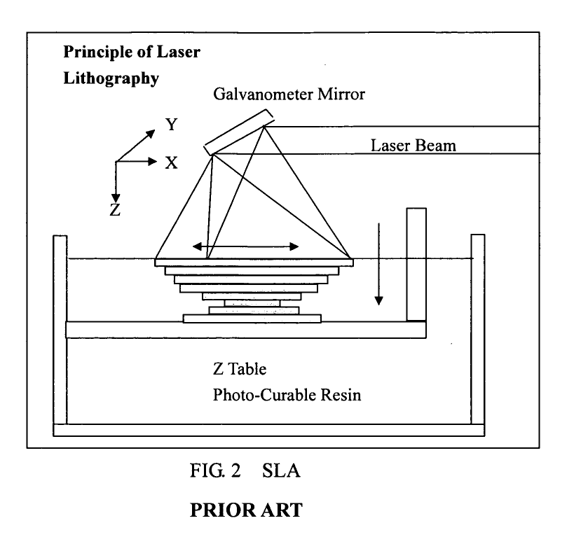

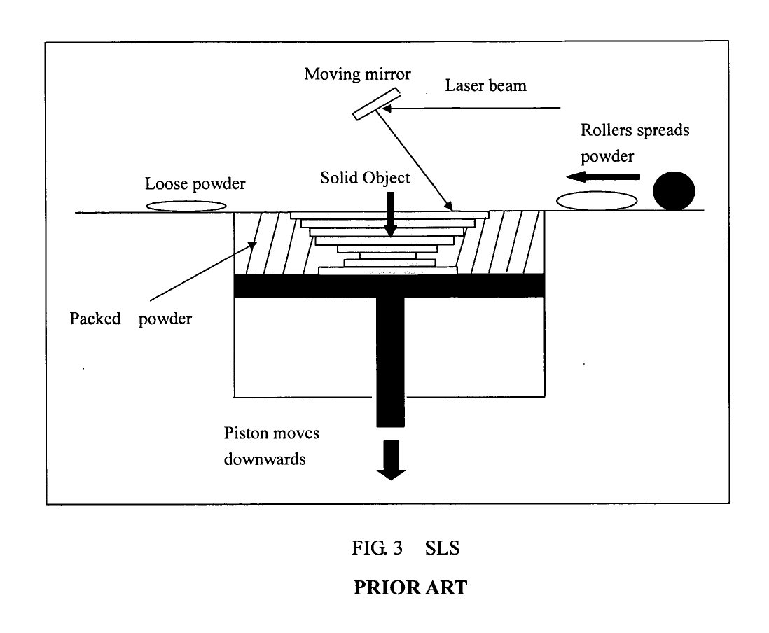

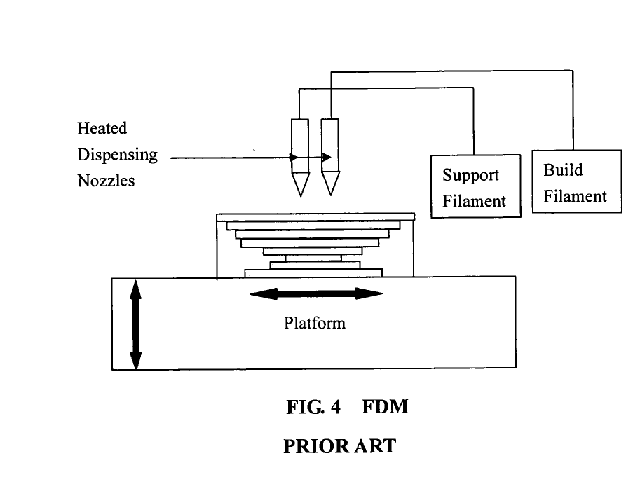

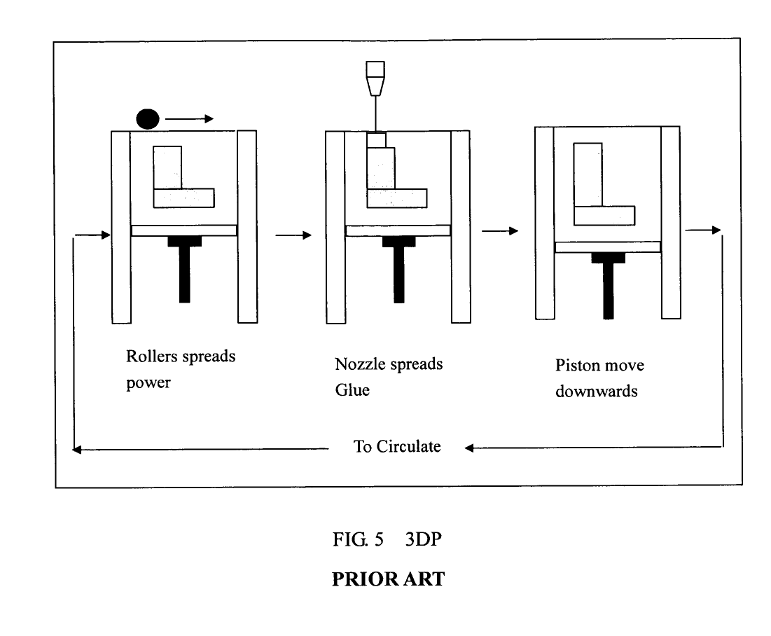

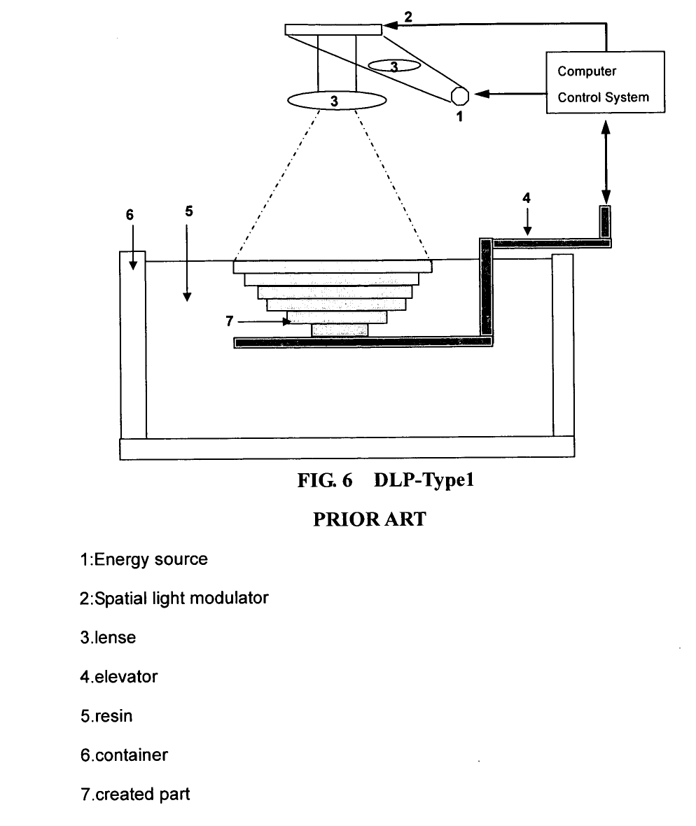

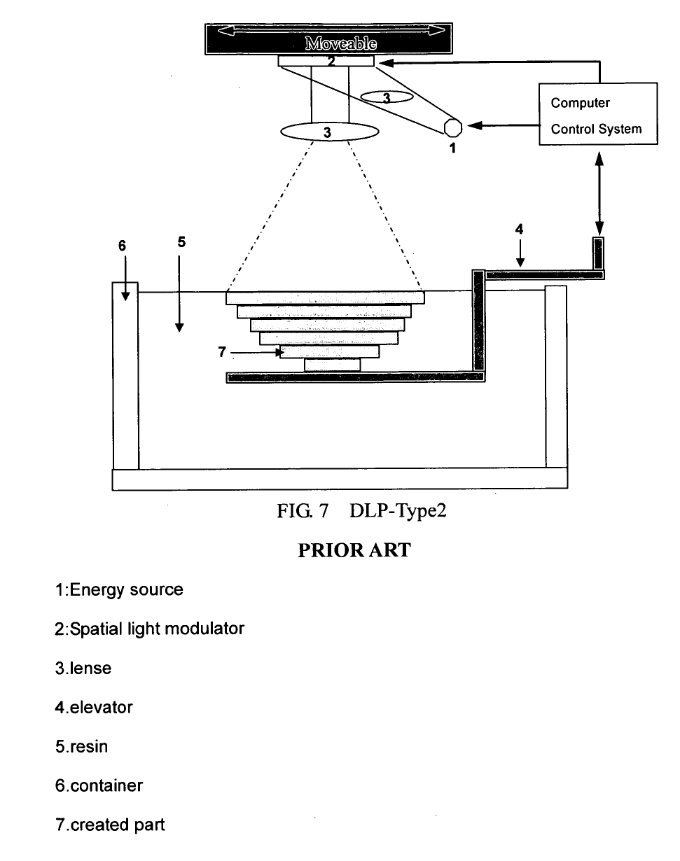

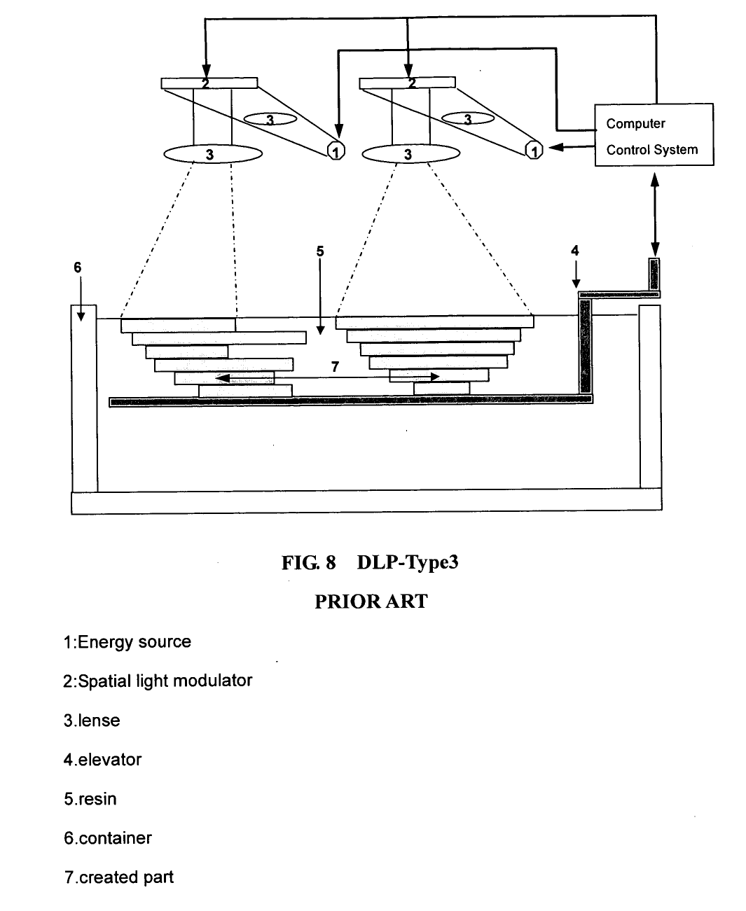

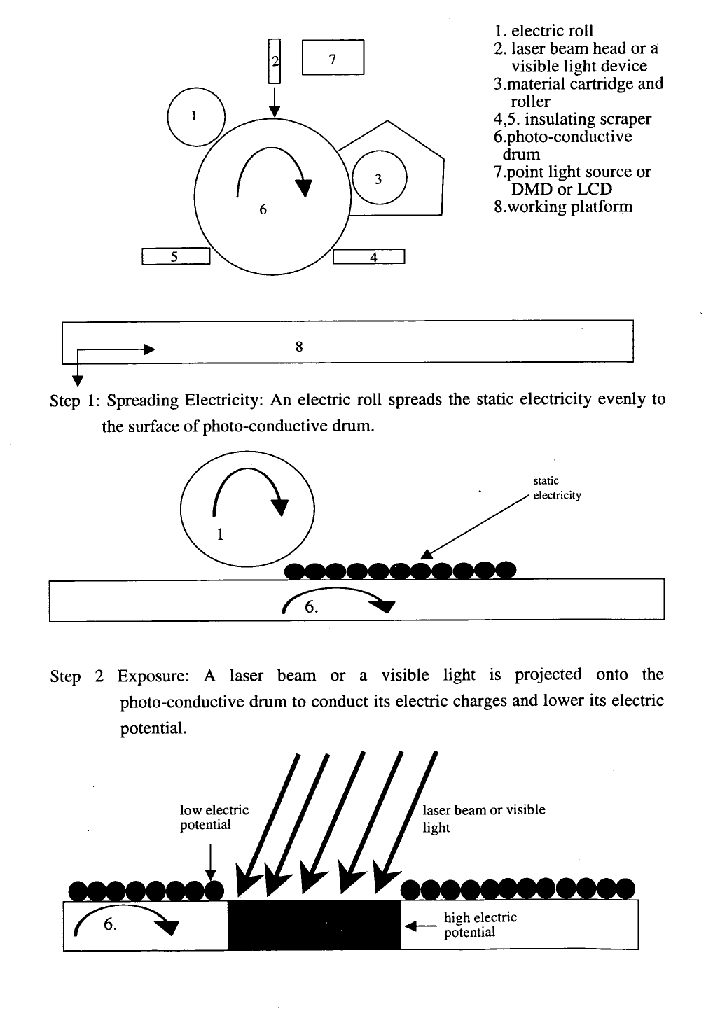

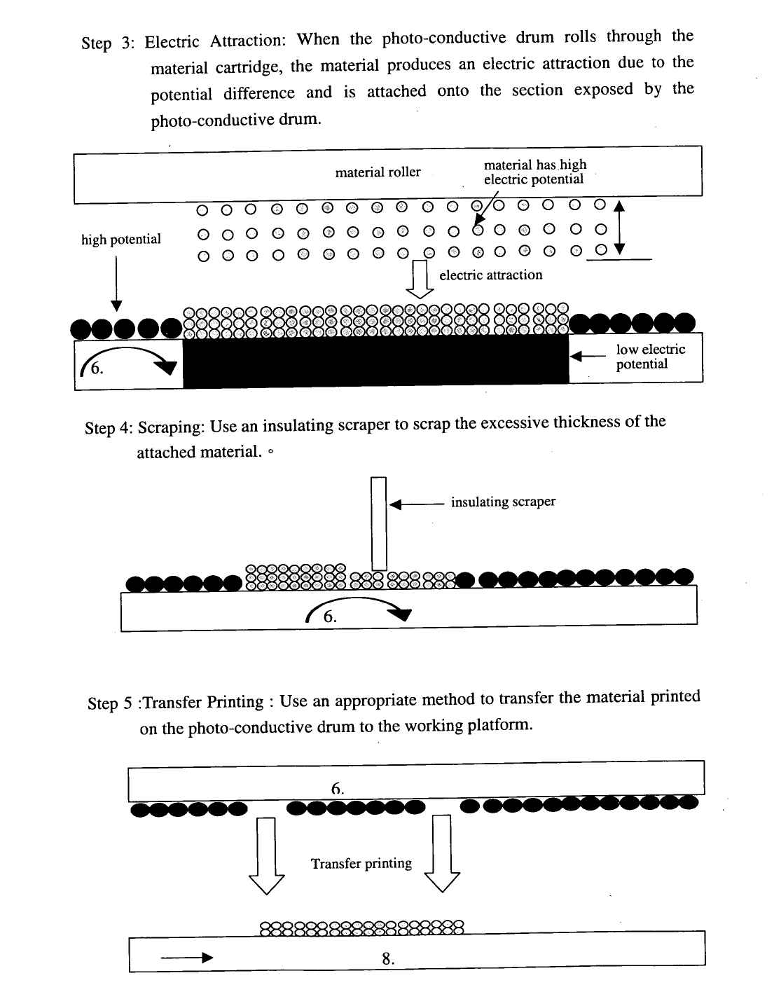

### DETAILED DESCRIPTION OF THE PREFERRED EMBODIMENTS

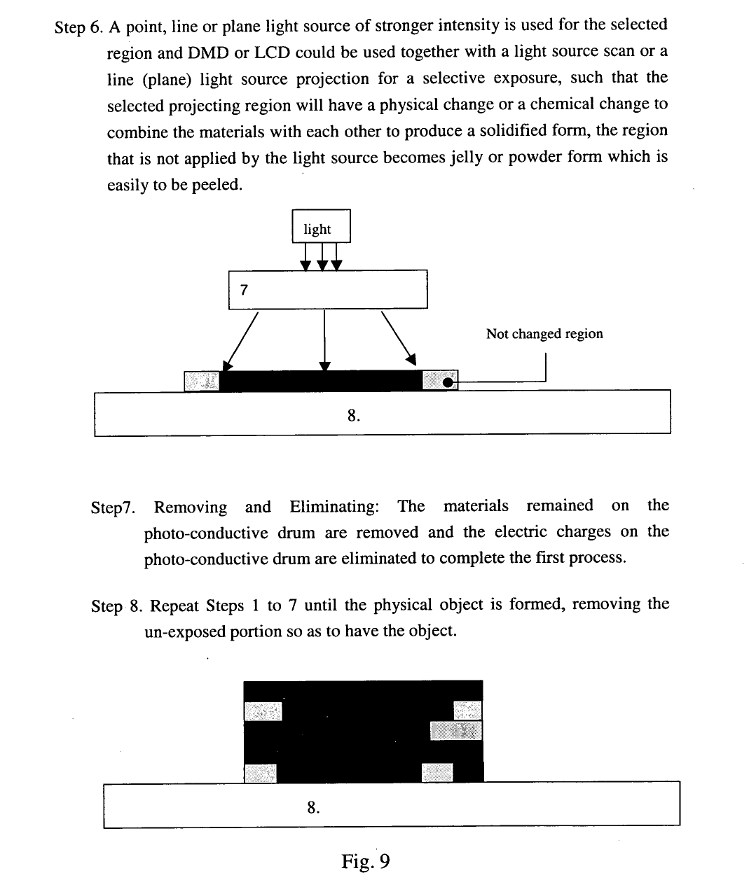

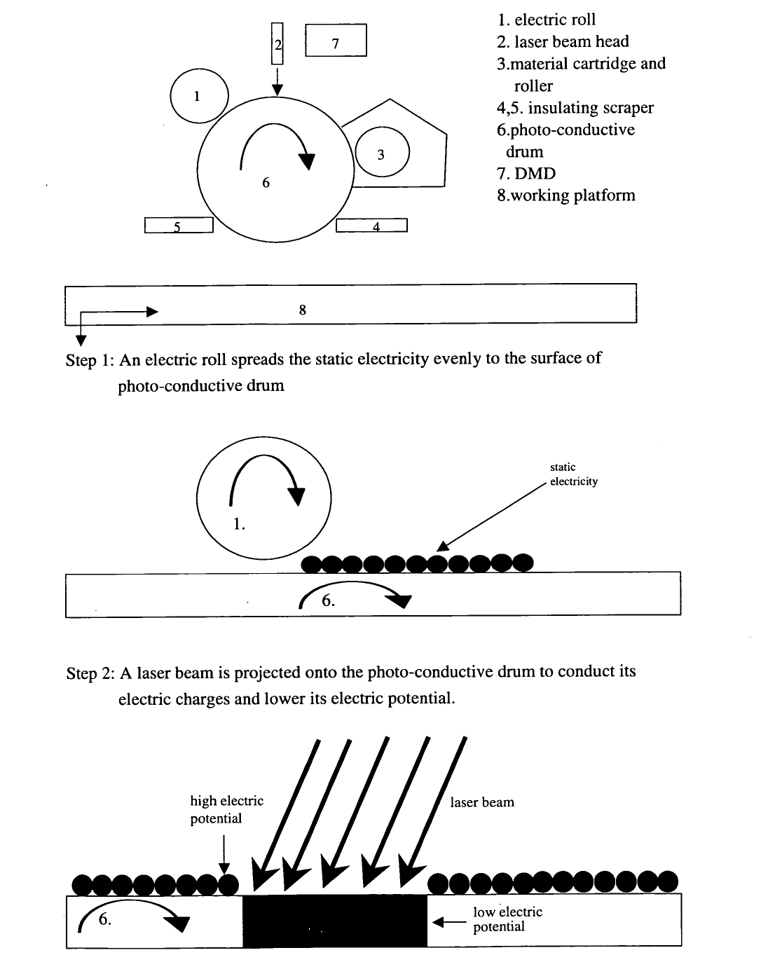

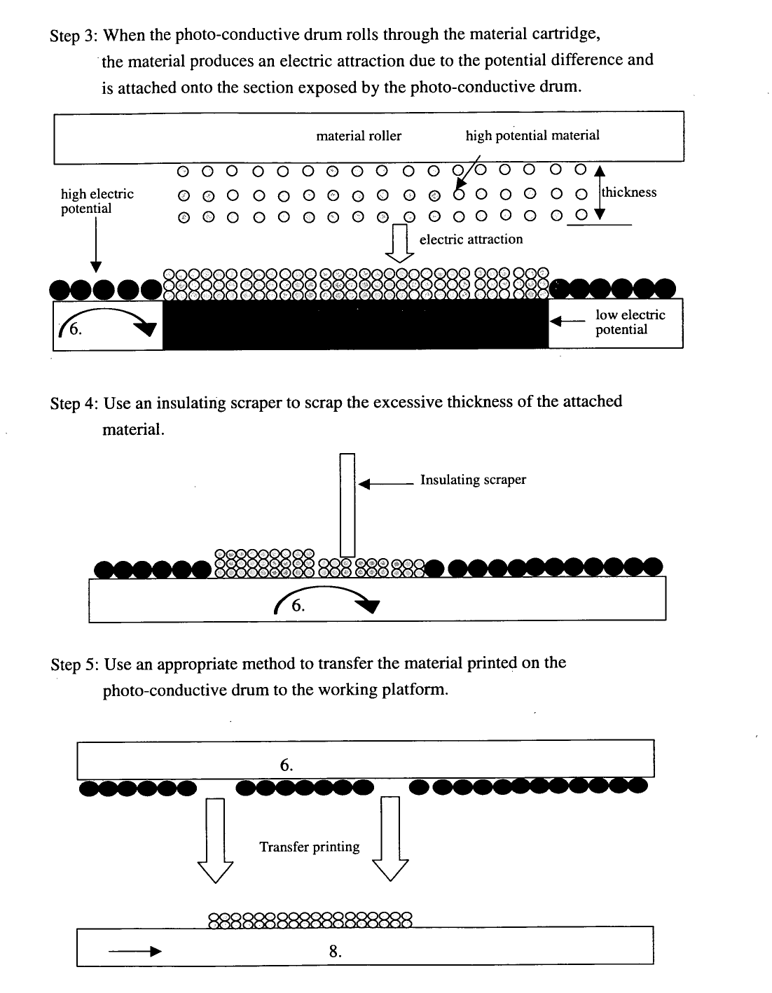

Referring to FIG. 9 for the manufacturing process employing the method of manufacturing rapid prototyping workpiece in accordance with the present invention, the basic manufacturing procedure is described as follows:
Step 1: An electric roll spreads the static electricity evenly to the surface of photo-conductive drum.
Step 2: A laser beam or a visible light is projected onto the photo-conductive drum to conduct its electric charges and lower its electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: A point, line or plane light source of stronger intensity is used for the selected region and DMD or LCD could be used together with a light source scan or a line (plane) light source projection for a selective exposure, such that the selected projecting region will have a physical change or a chemical change to combine the materials with each other to produce an acceptable property.
Step 7: The materials remained on the photo-conductive drum are removed and the electric charges on the photo-conductive drum are eliminated.
Step 8: Repeat Steps 1 to 7 until the physical object is formed.

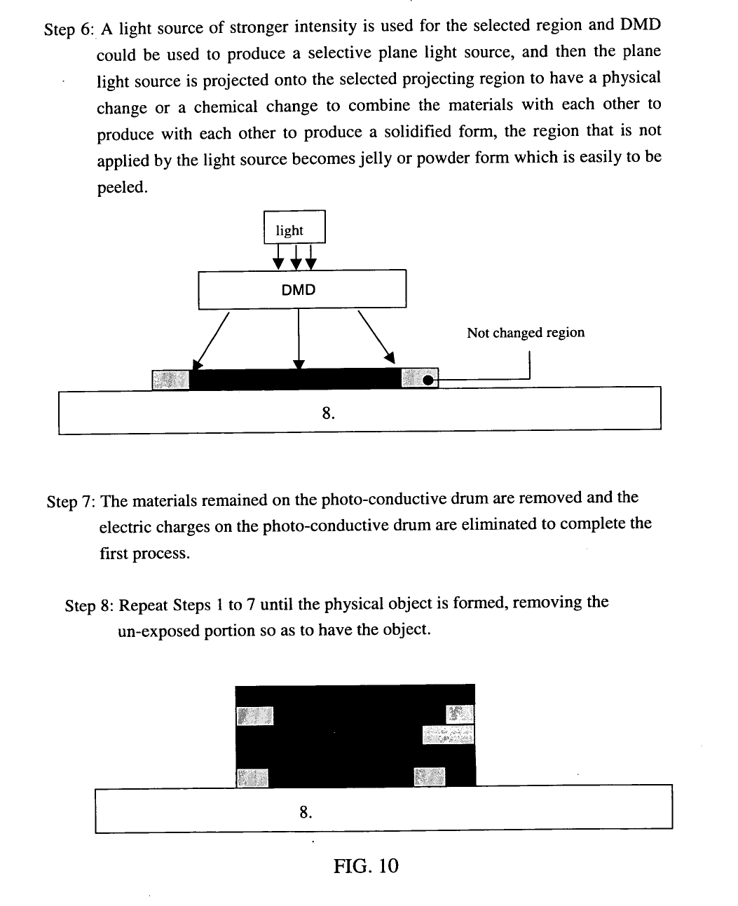

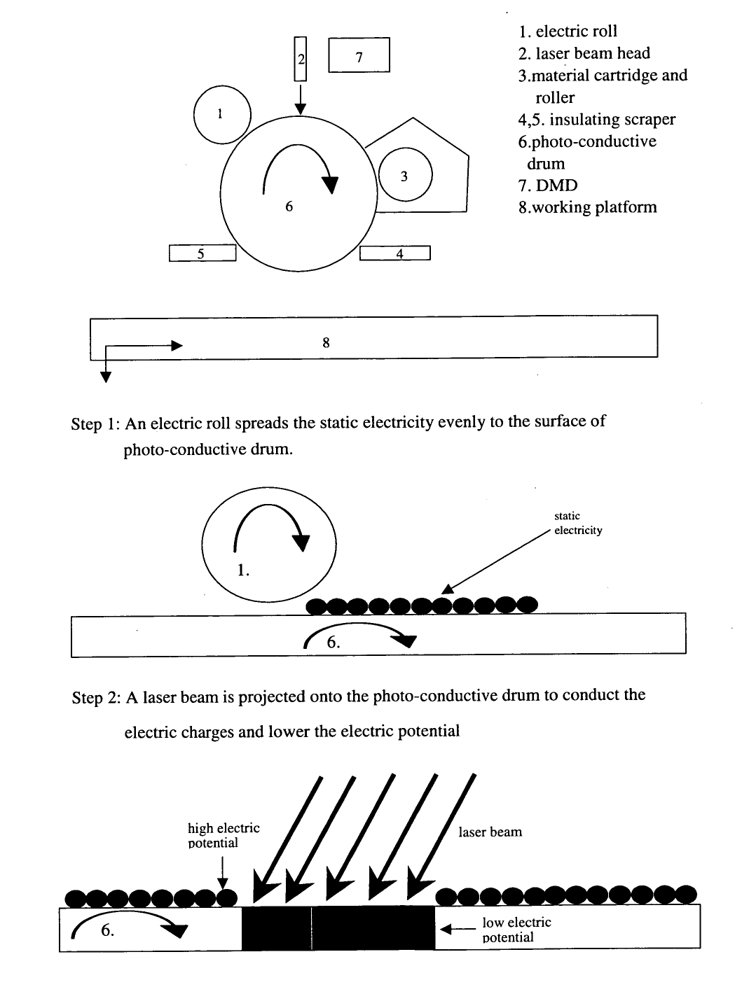

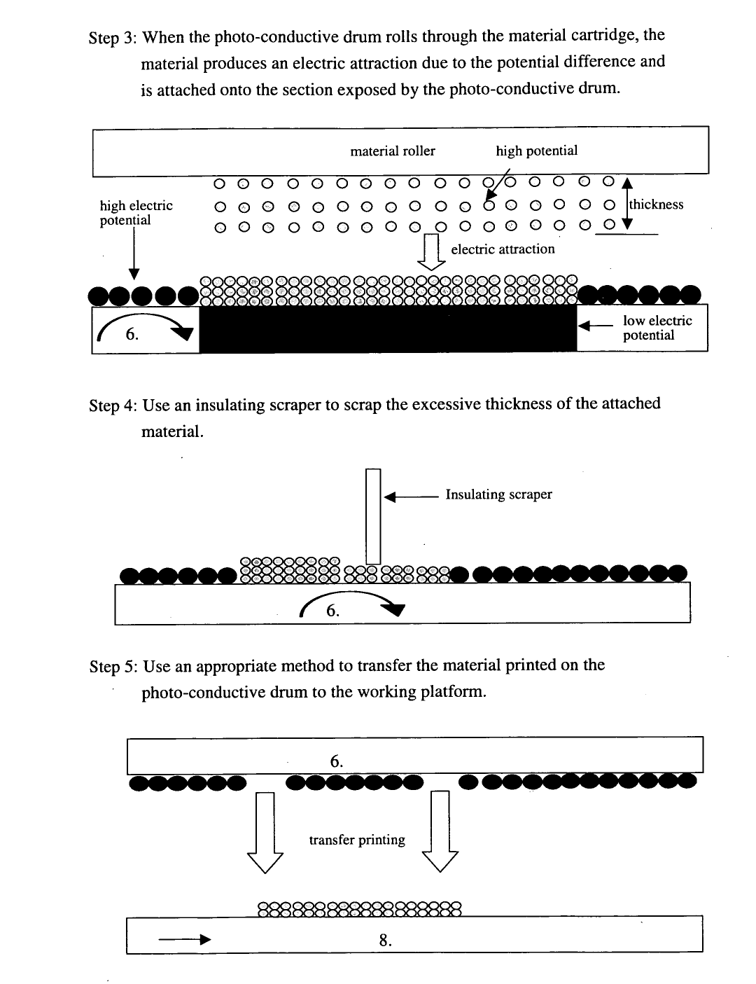

Referring to FIG. 10 for the method of manufacturing rapid prototyping workpiece according to a first preferred embodiment of the present invention, the basic manufacturing procedure comprises the following steps:
Step 1: An electric roll spreads the static electricity evenly to the surface of photo-conductive drum.
Step 2: A laser beam is projected onto the photo-conductive drum to conduct its electric charges and lower its electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: A light source of stronger intensity is used for the selected region and DMD could be used to produce a selective line light source, and then the line light source is projected onto the selected projecting region to have a physical change or a chemical change to combine the materials with each other to produce an acceptable property.
Step 7: The materials remained on the photo-conductive drum are removed and the electric charges on the photo-conductive drum are eliminated.
Step 8: Repeat Steps 1 to 7 until the physical object is formed.

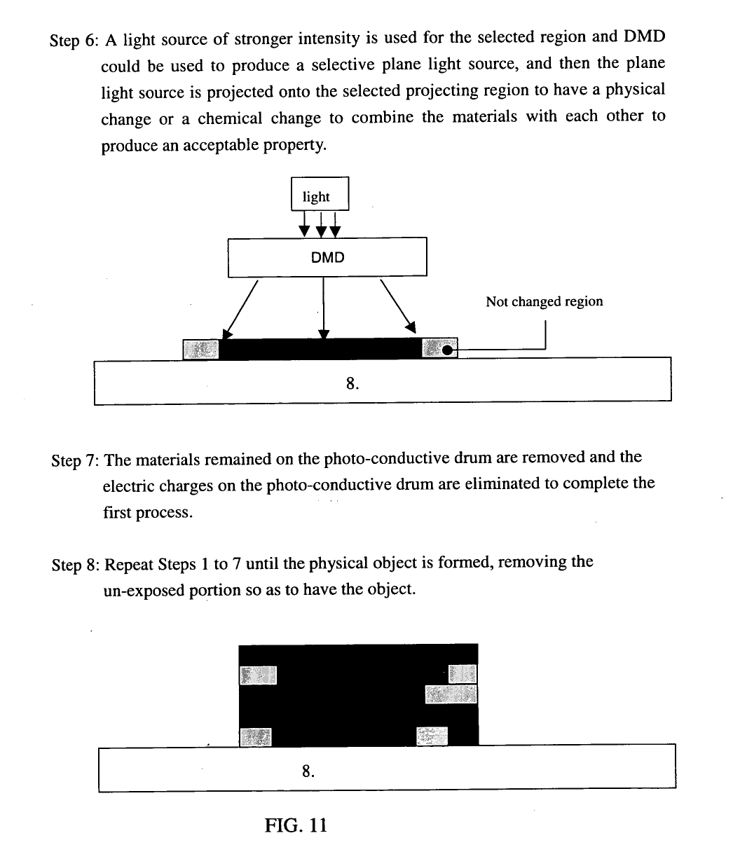

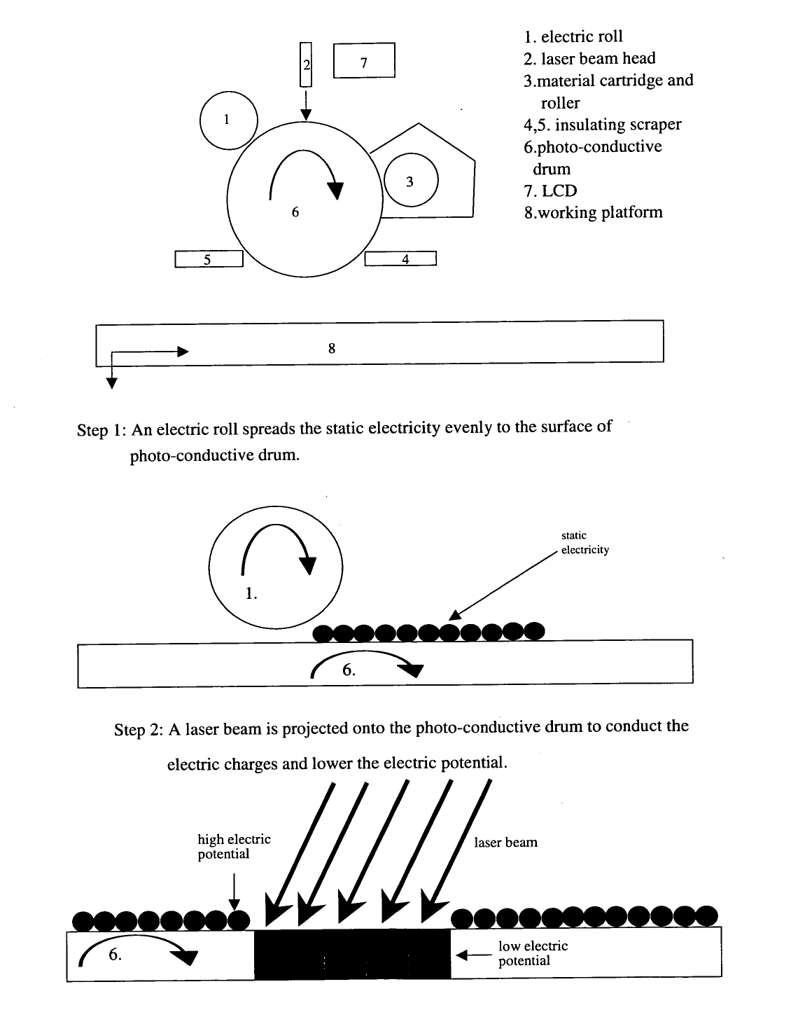

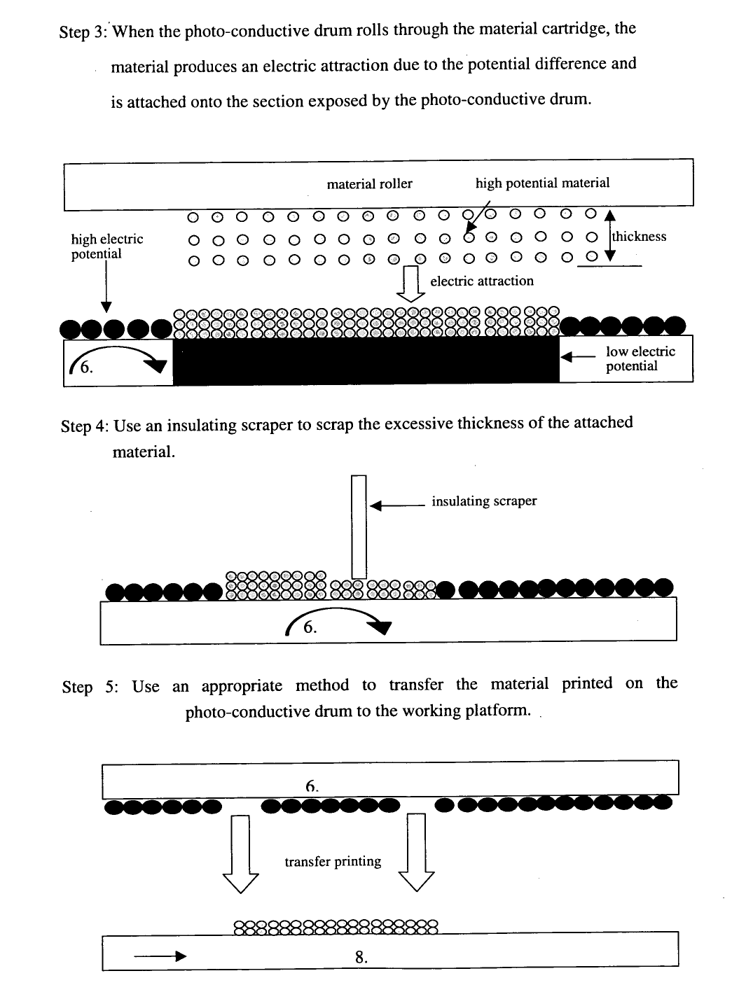

Referring to FIG. 11 for the method of manufacturing rapid prototyping workpiece according to a second preferred embodiment of the present invention, the basic manufacturing procedure comprises the following steps:
Step 1: An electric roll spreads the static electricity evenly to the surface of photo-conductive drum.
Step 2: A laser beam is projected onto the photo-conductive drum to conduct the electric charges and lower the electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: A light source of stronger intensity is used for the selected region and DMD could be used to produce a selective line light source, and then the line light source is projected onto the selected projecting region to have a physical change or a chemical change to combine the materials with each other to produce an acceptable property.
Step 7: The materials remained on the photo-conductive drum are removed and the electric charges on the photo-conductive drum are eliminated.
Step 8: Repeat Steps 1 to 7 until the physical object is formed.

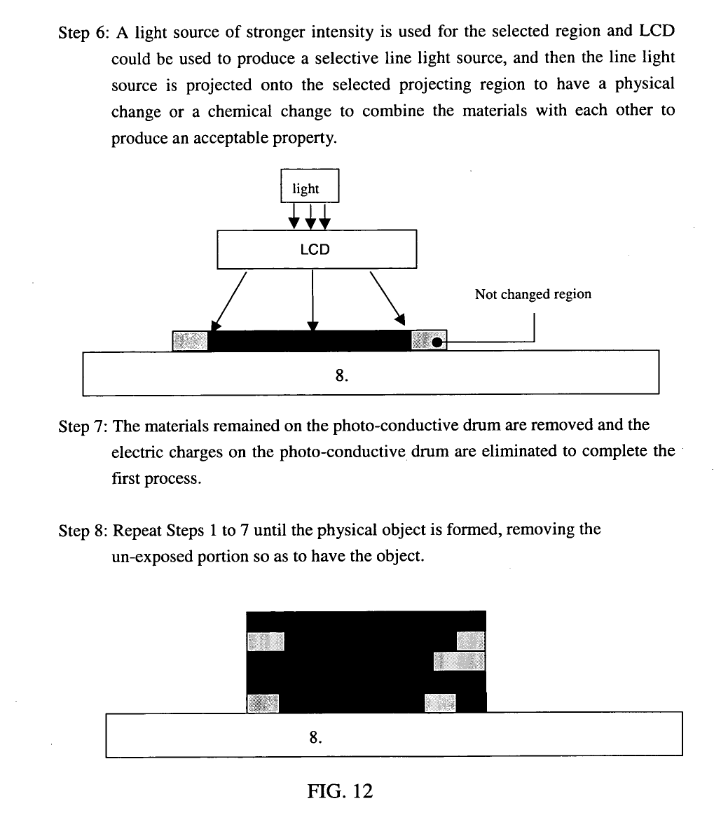

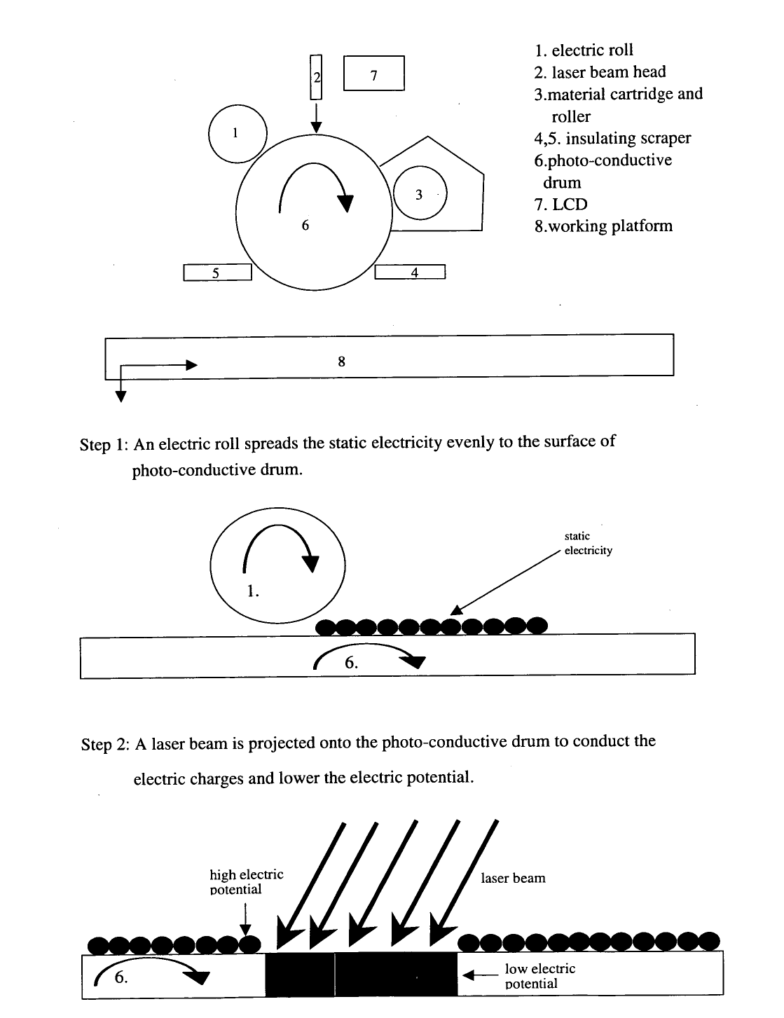

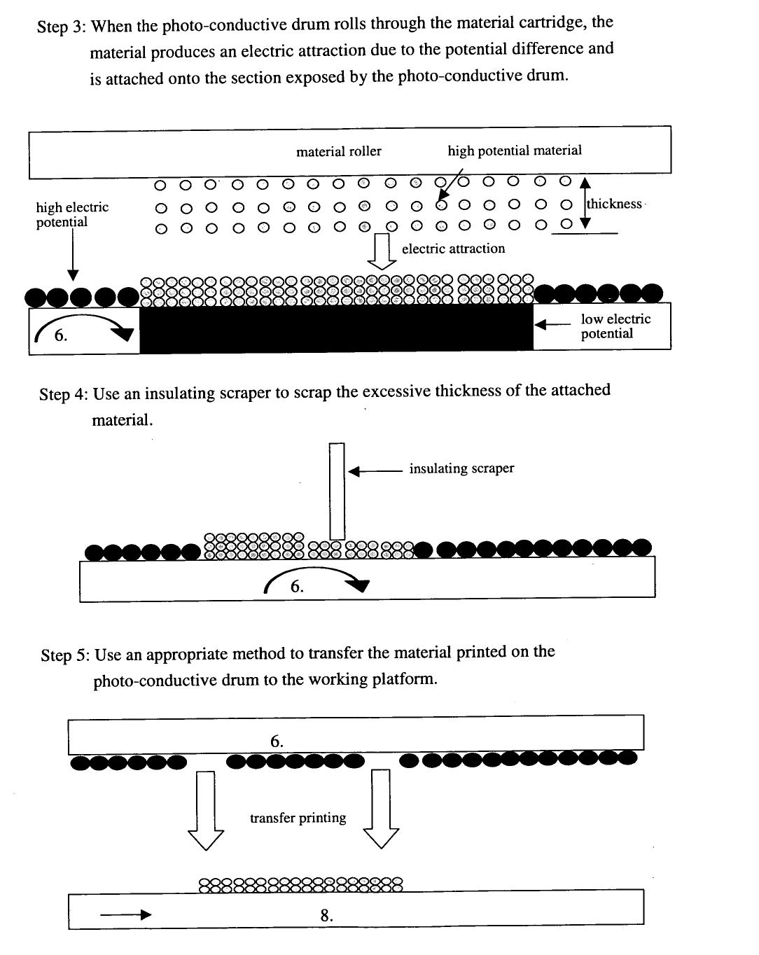

Referring to FIG. 12 for the method of manufacturing rapid prototyping workpiece according to a third preferred embodiment of the present invention, the basic manufacturing procedure comprises the following steps:
Step 1: An electric roll spreads the static electricity evenly to the surface of photo-conductive drum.
Step 2: A laser beam is projected onto the photo-conductive drum to conduct the electric charges and lower the electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: A light source of stronger intensity is used for the selected region and LCD could be used to produce a selective line light source, and then the line light source is projected onto the selected projecting region to have a physical change or a chemical change to combine the materials with each other to produce an acceptable property.
Step 7: The materials remained on the photo-conductive drum are removed and the electric charges on the photo-conductive drum are eliminated.
Step 8: Repeat Steps 1 to 7 until the physical object is formed.

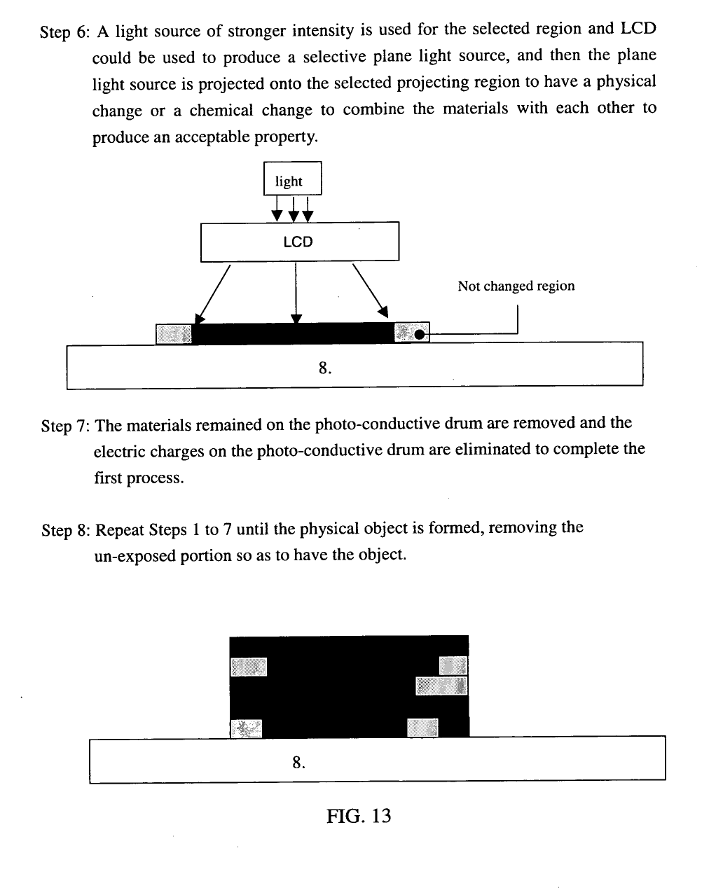

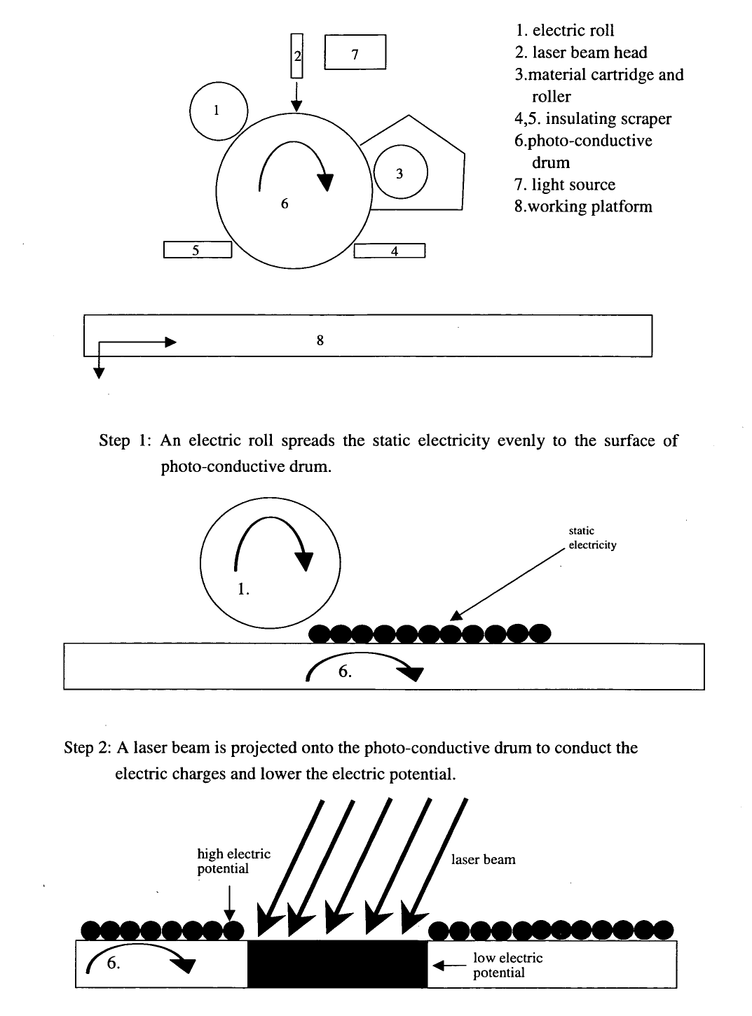

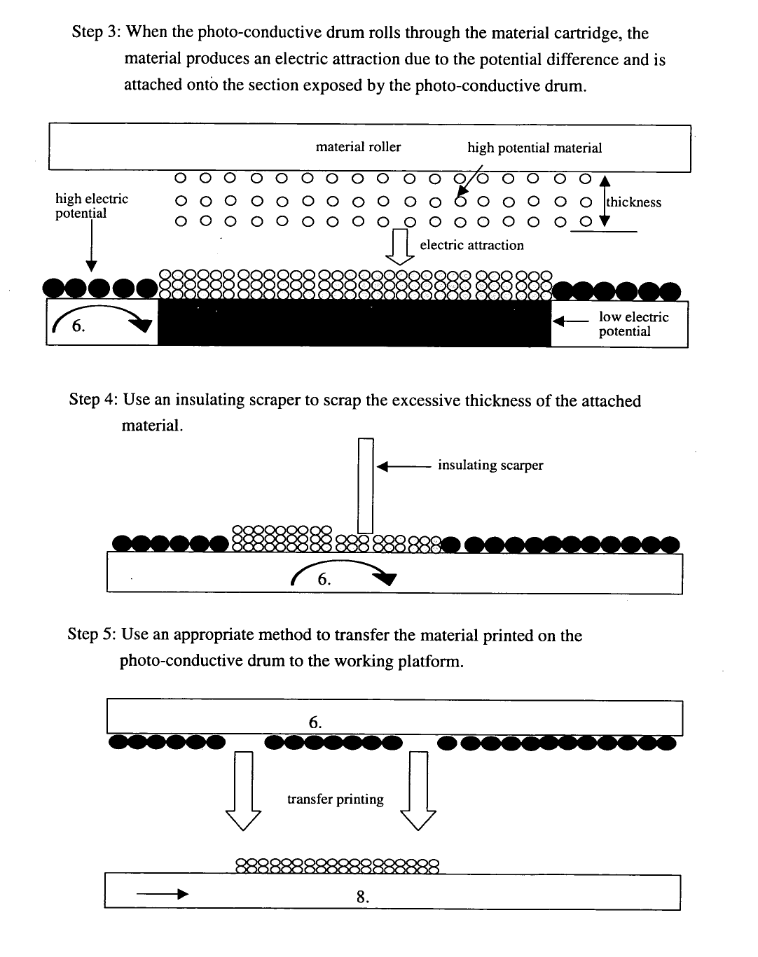

Referring to FIG. 13 for the method of manufacturing rapid prototyping workpiece according to a fourth preferred embodiment of the present invention, the basic manufacturing procedure comprises the following steps:
Step 1: An electric roll spreads the static electricity evenly to the surface of photo-conductive drum.
Step 2: A laser beam is projected onto the photo-conductive drum to conduct the electric charges and lower the electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: A light source of stronger intensity is used for the selected region and LCD could be used to produce a selective line light source, and then the line light source is projected onto the selected projecting region to have a physical change or a chemical change to combine the materials with each other to produce an acceptable property.
Step 7: The materials remained on the photo-conductive drum are removed and the electric charges on the photo-conductive drum are eliminated.
Step 8: Repeat Steps 1 to 7 until the physical object is formed.

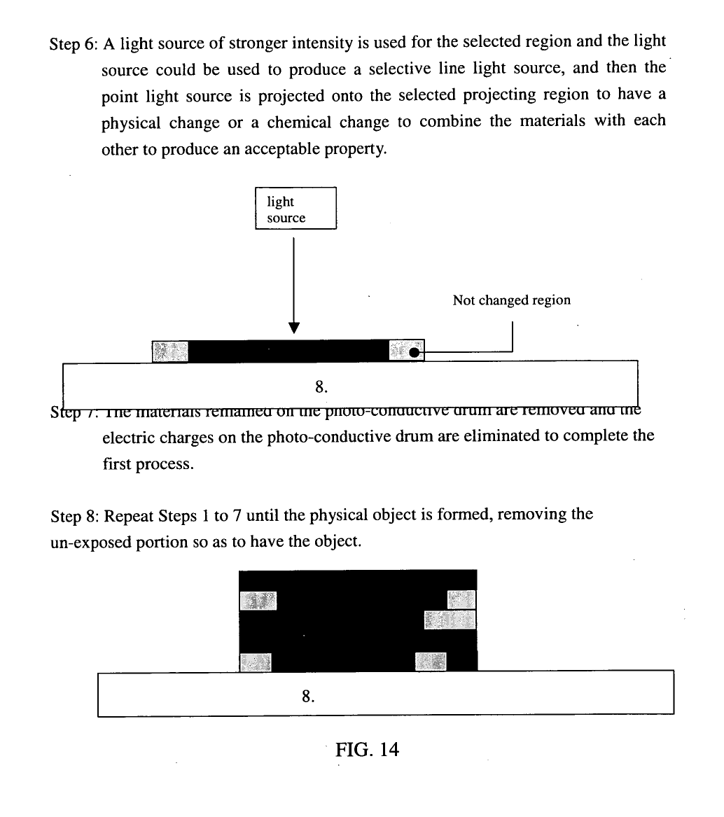

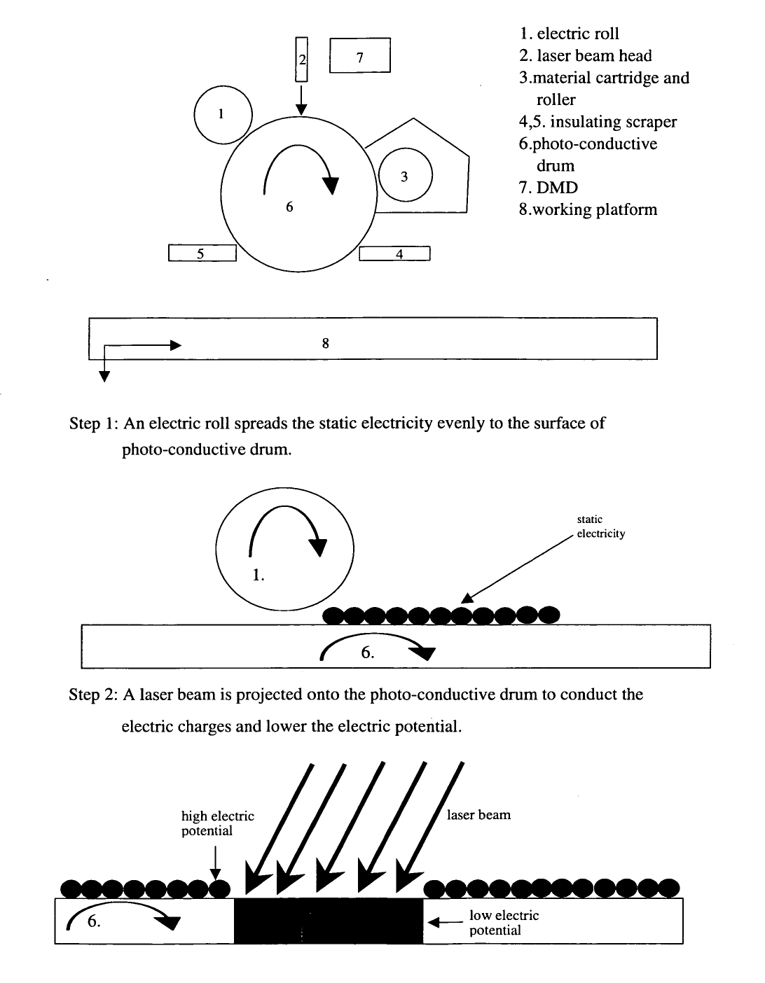

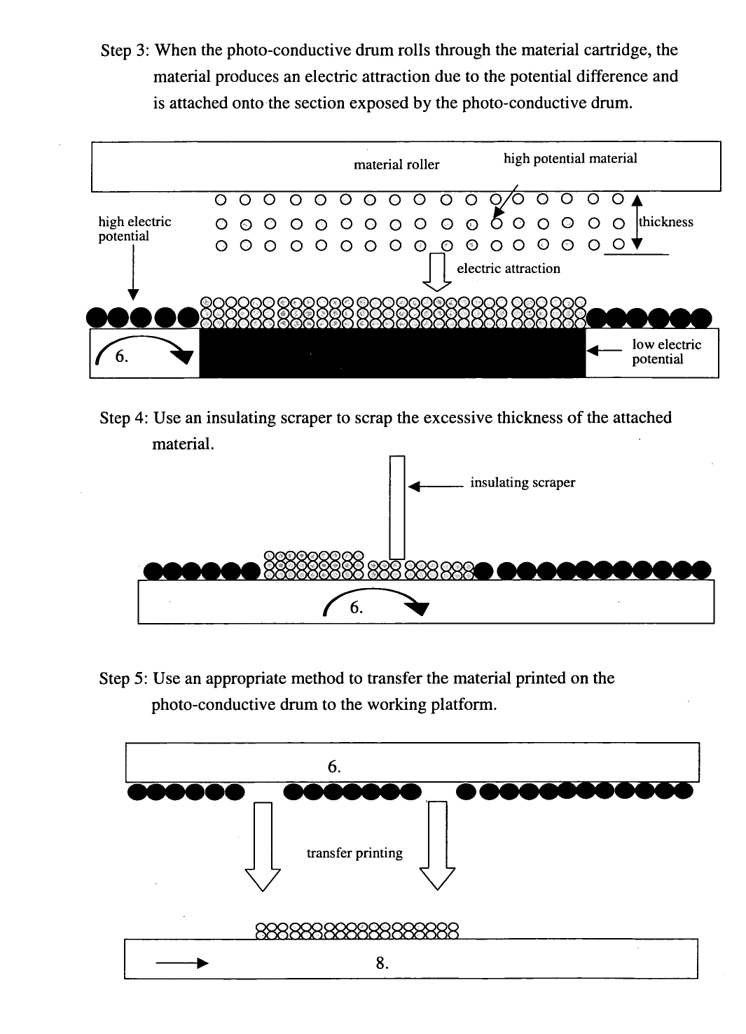

Referring to FIG. 14 for the method of manufacturing rapid prototyping workpiece according to a fifth preferred embodiment of the present invention, the basic manufacturing procedure comprises the following steps:
Step 1: An electric roll spreads the static electricity evenly to the surface of photo-conductive drum.
Step 2: A laser beam is projected onto the photo-conductive drum to conduct the electric charges and lower the electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: A selective point light source of stronger intensity is used for scanning and projecting the selected region a physical change or a chemical change to combine the materials with each other to produce an acceptable property.
Step 7: The materials remained on the photo-conductive drum are removed and the electric charges on the photo-conductive drum are eliminated.
Step 8: Repeat Steps 1 to 7 until the physical object is formed.

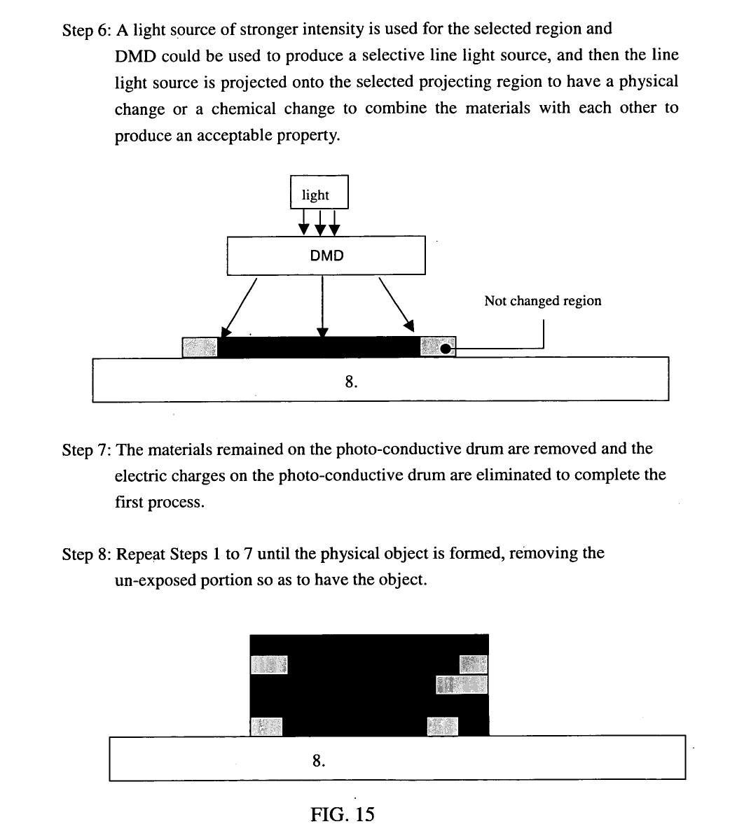

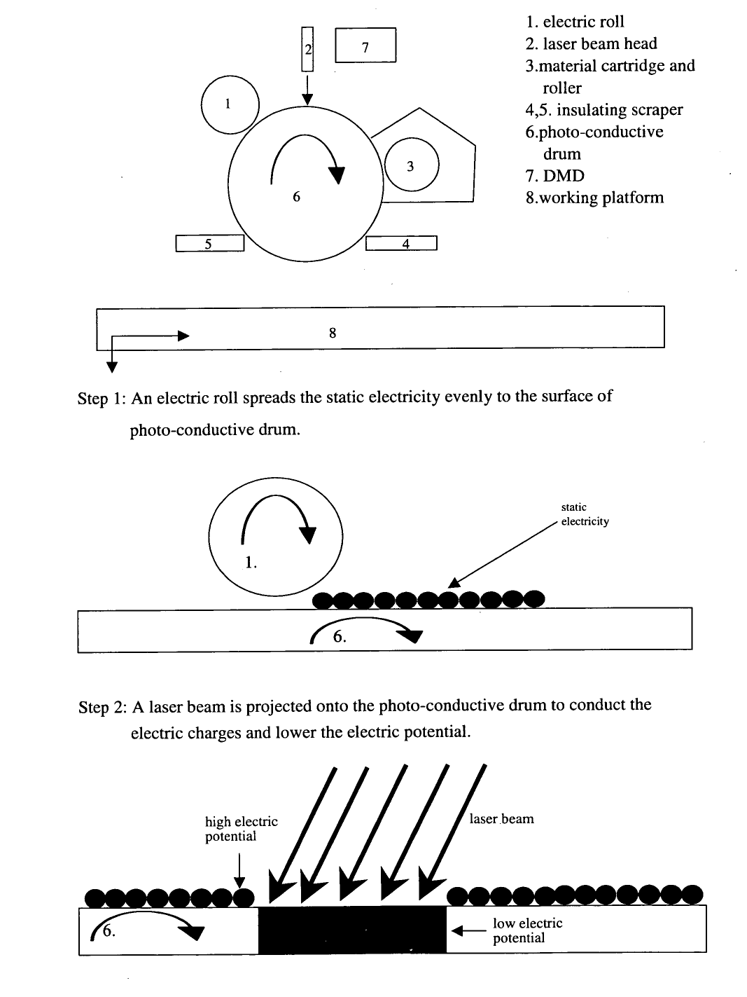

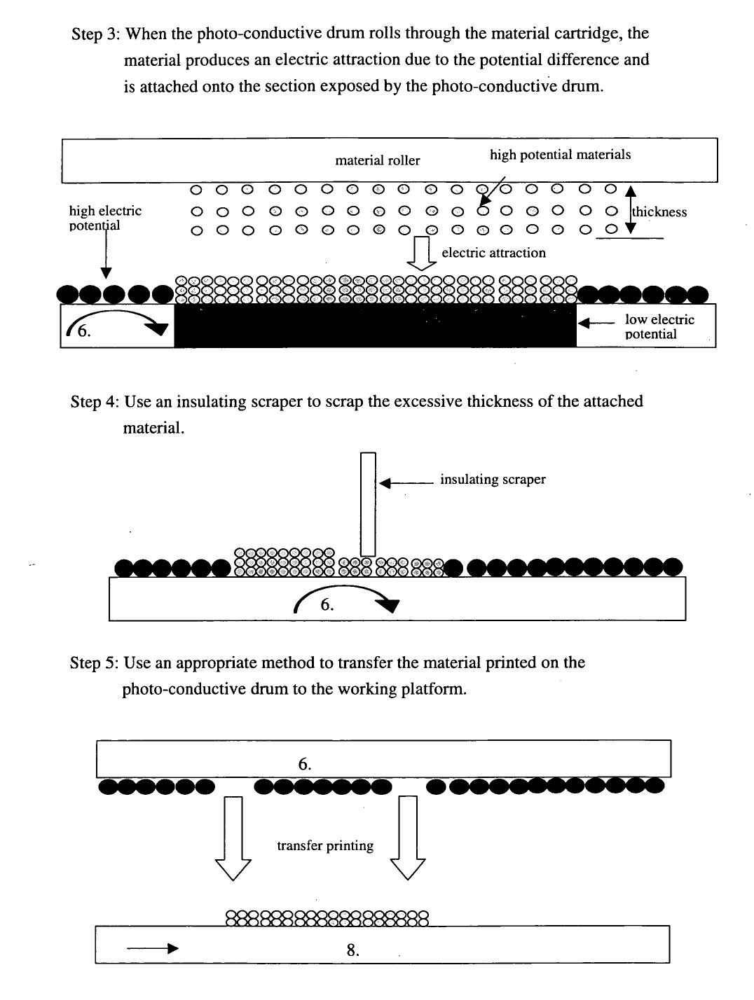

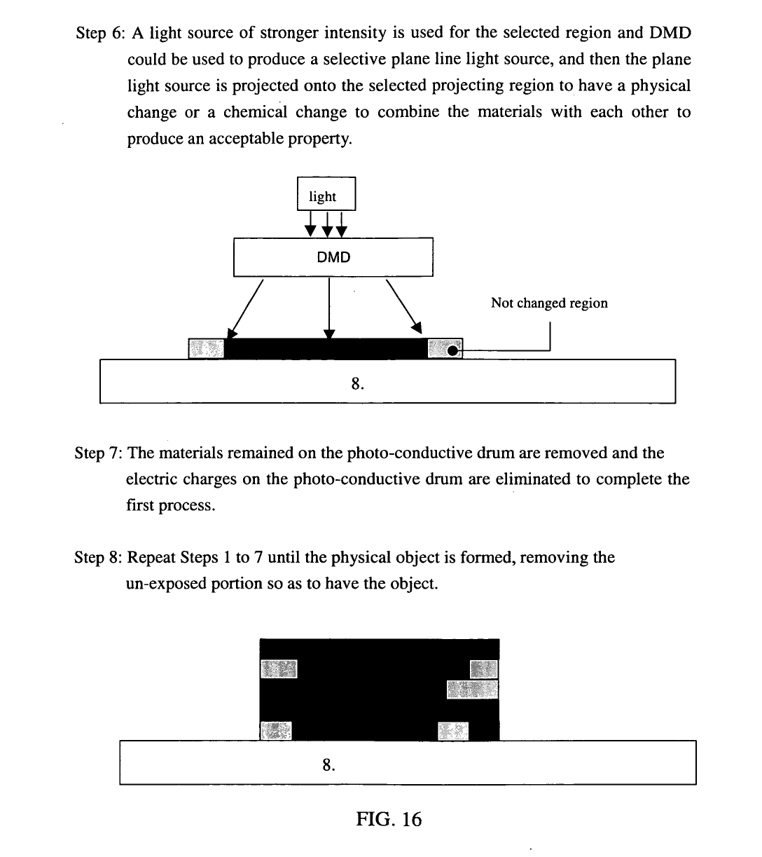

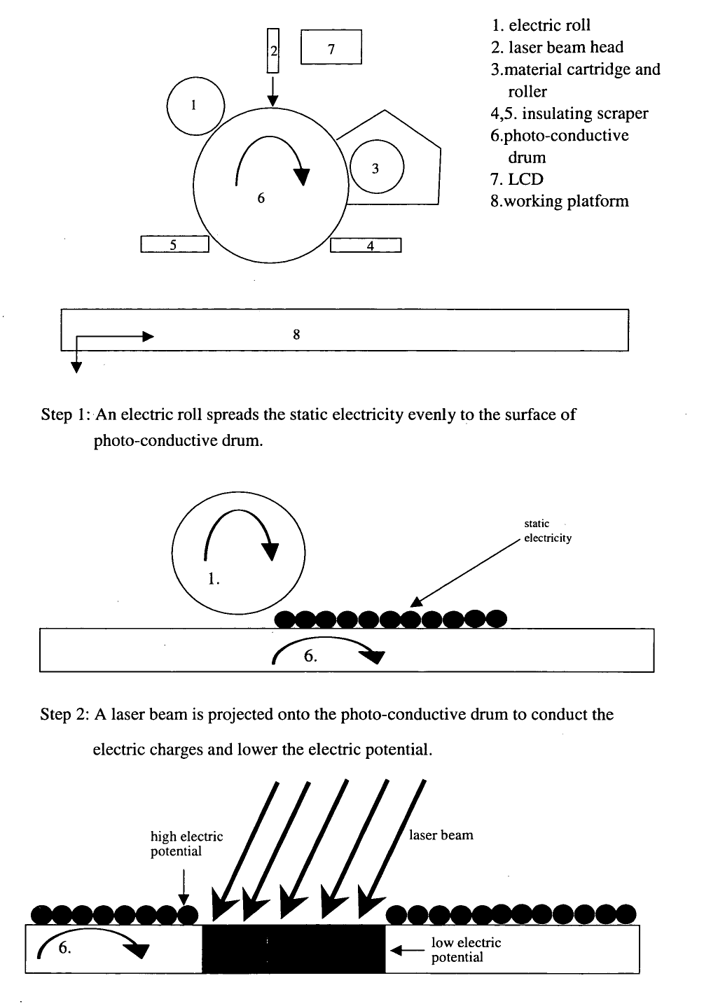

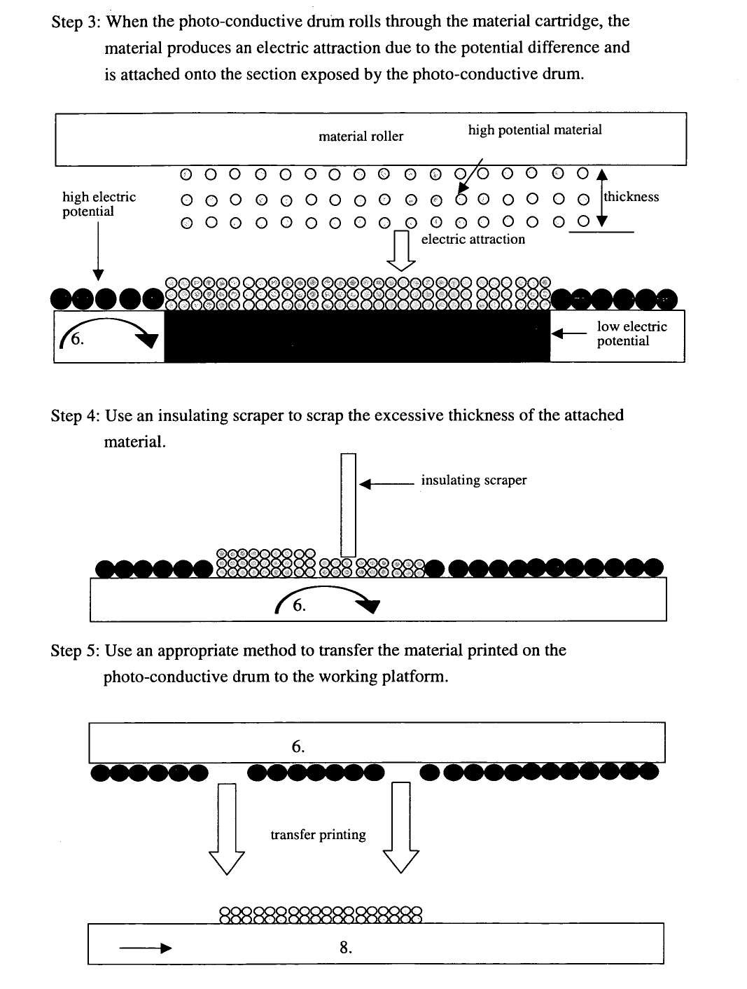

Referring to FIG. 15 for the method of manufacturing rapid prototyping workpiece according to a sixth preferred embodiment of the present invention, the basic manufacturing procedure comprises the following steps:
Step 1: An electric roll spreads the static electricity evenly to the surface of photo-conductive drum.
Step 2: A visible light is projected onto the photo-conductive drum to conduct the electric charges and lower the electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: A light source of stronger intensity is used for the selected region and DMD could be used to produce a selective line light source, and then the line light source is projected onto the selected projecting region to have a physical change or a chemical change to combine the materials with each other to produce an acceptable property.
Step 7: The materials remained on the photo-conductive drum are removed and the electric charges on the photo-conductive drum are eliminated.
Step 8: Repeat Steps 1 to 7 until the physical object is formed.

Referring to FIG. 16 for the method of manufacturing rapid prototyping workpiece according to a seventh preferred embodiment of the present invention, the basic manufacturing procedure comprises the following steps:
Step 1: An electric roll spreads the static electricity evenly to the surface of photo-conductive drum.
Step 2: A visible light is projected onto the photo-conductive drum to conduct its electric charges and lower its electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: A light source of stronger intensity is used for the selected region and DMD could be used to produce a selective line light source, and then the line light source is projected onto the selected projecting region to have a physical change or a chemical change to combine the materials with each other to produce an acceptable property.
Step 7: The materials remained on the photo-conductive drum are removed and the electric charges on the photo-conductive drum are eliminated.
Step 8: Repeat Steps 1 to 7 until the physical object is formed.

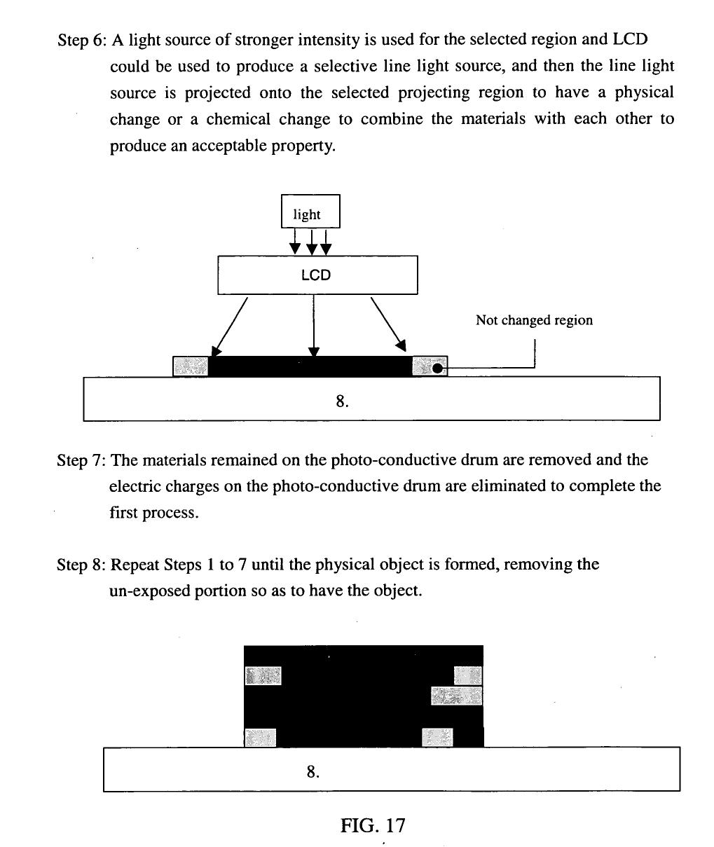

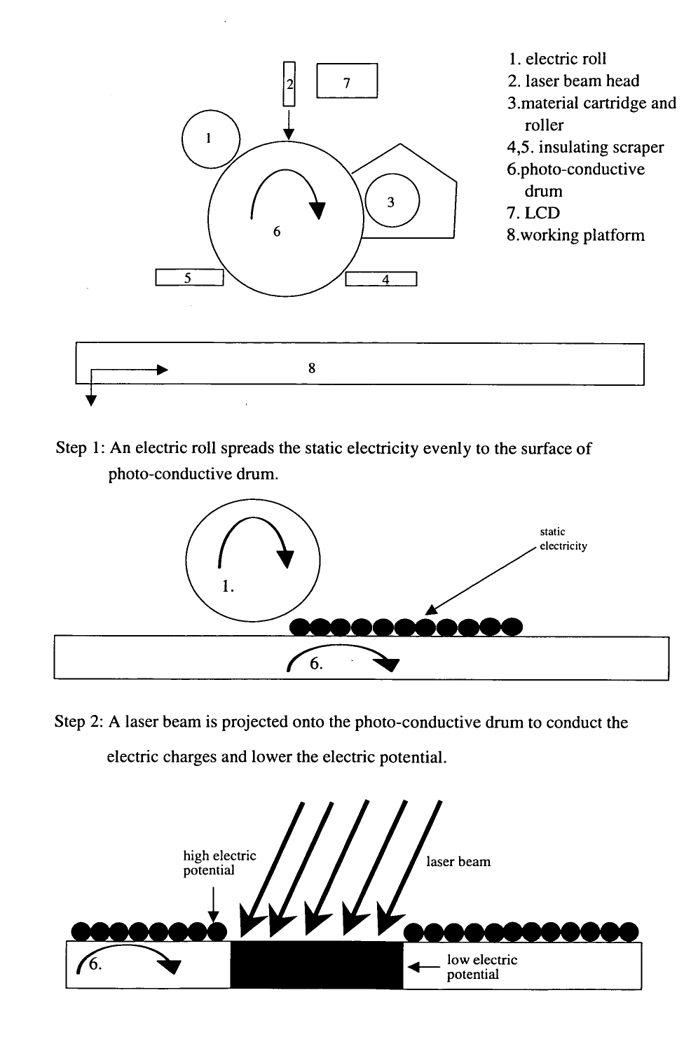

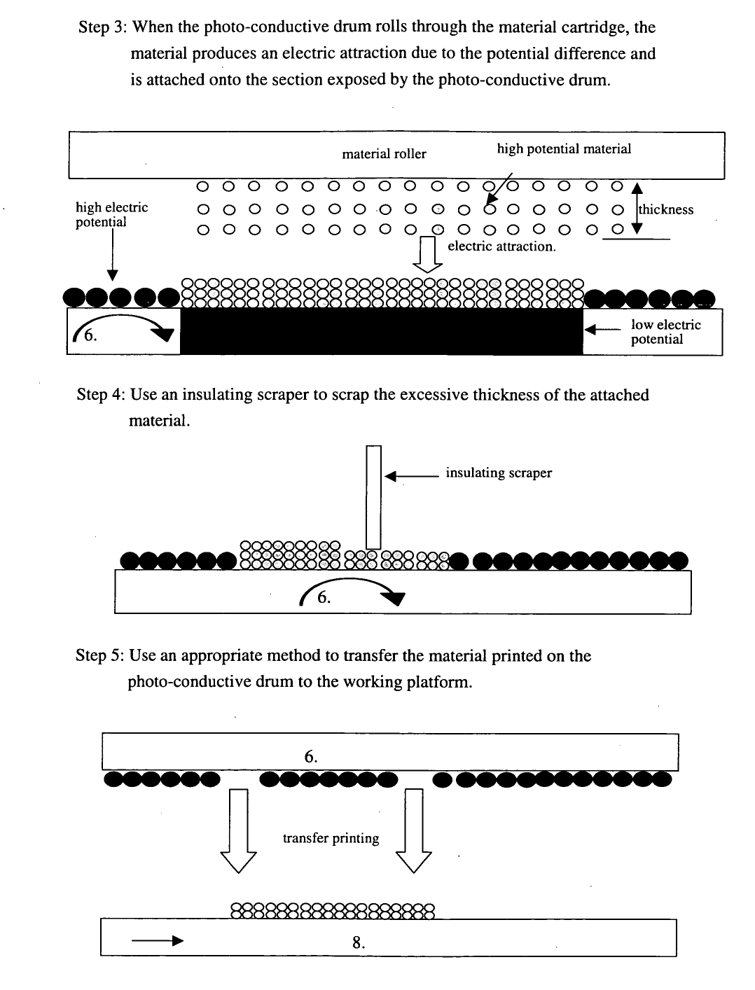

Referring to FIG. 17 for the method of manufacturing rapid prototyping workpiece according to an eighth preferred embodiment of the present invention, the basic manufacturing procedure comprises the following steps:
Step 1: An electric roll spreads the static electricity evenly to the surface of photo-conductive drum.
Step 2: A visible light is projected onto the photo-conductive drum to conduct its electric charges and lower its electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: A light source of stronger intensity is used for the selected region and LCD could be used to produce a selective line light source, and then the line light source is projected onto the selected projecting region to have a physical change or a chemical change to combine the materials with each other to produce an acceptable property.
Step 7: The materials remained on the photo-conductive drum are removed and the electric charges on the photo-conductive drum are eliminated.
Step 8: Repeat Steps 1 to 7 until the physical object is formed.

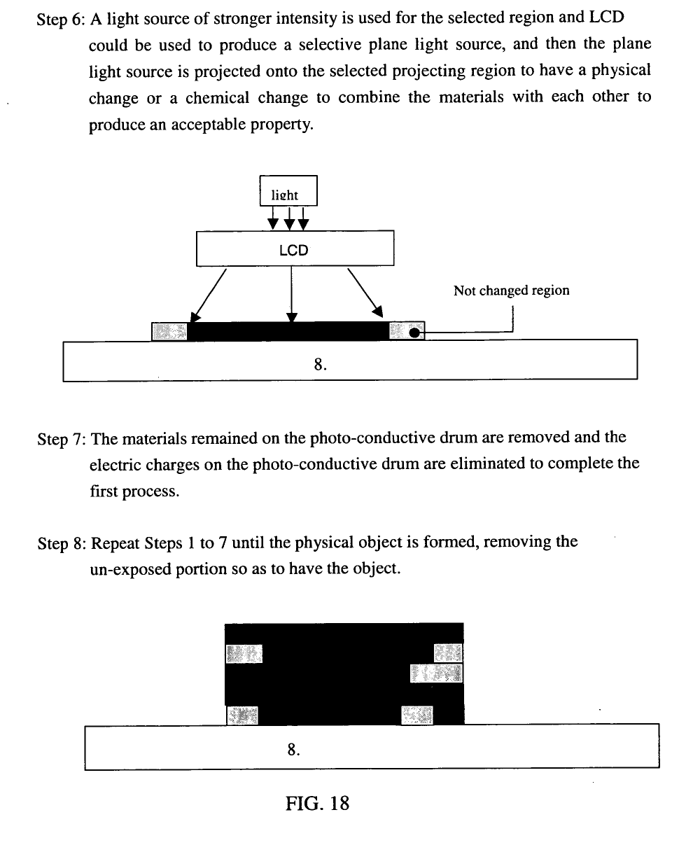

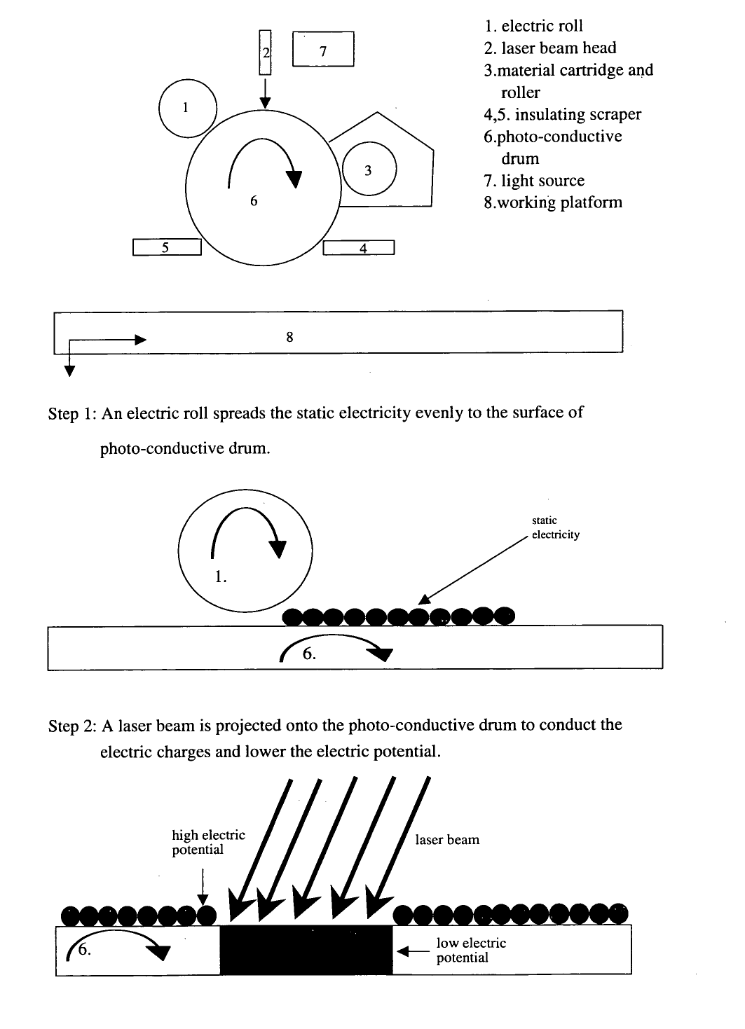

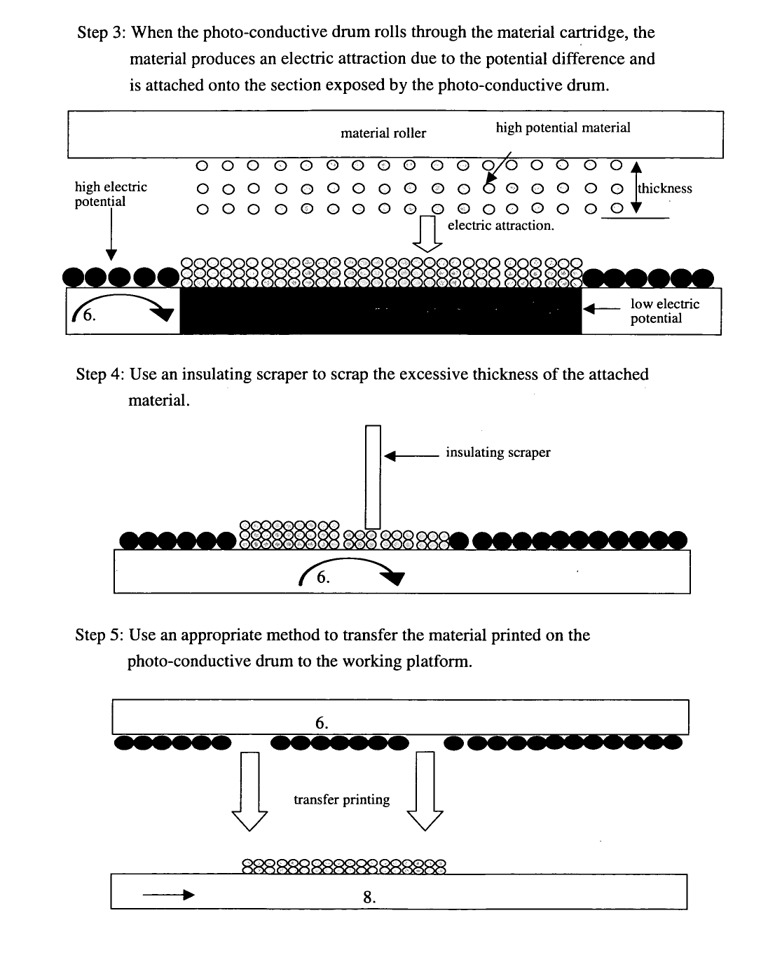

Referring to FIG. 18 for the method of manufacturing rapid prototyping workpiece according to a ninth preferred embodiment of the present invention, the basic manufacturing procedure comprises the following steps:
Step 1: An electric roll spreads the static electricity evenly to the surface of photo-conductive drum.
Step 2: A visible light is projected onto the photo-conductive drum to conduct its electric charges and lower its electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: A light source of stronger intensity is used for the selected region and LCD could be used to produce a selective plane light source, and then the plane light source is projected onto the selected projecting region to have a physical change or a chemical change to combine the materials with each other to produce an acceptable property.
Step 7: The materials remained on the photo-conductive drum are removed and the electric charges on the photo-conductive drum are eliminated.
Step 8: Repeat Steps 1 to 7 until the physical object is formed.

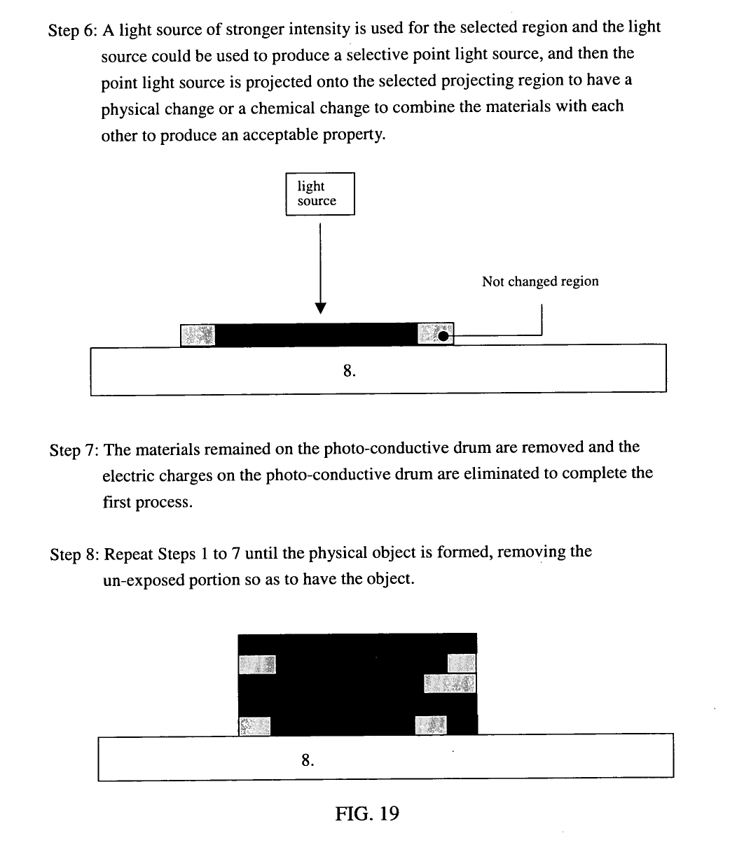

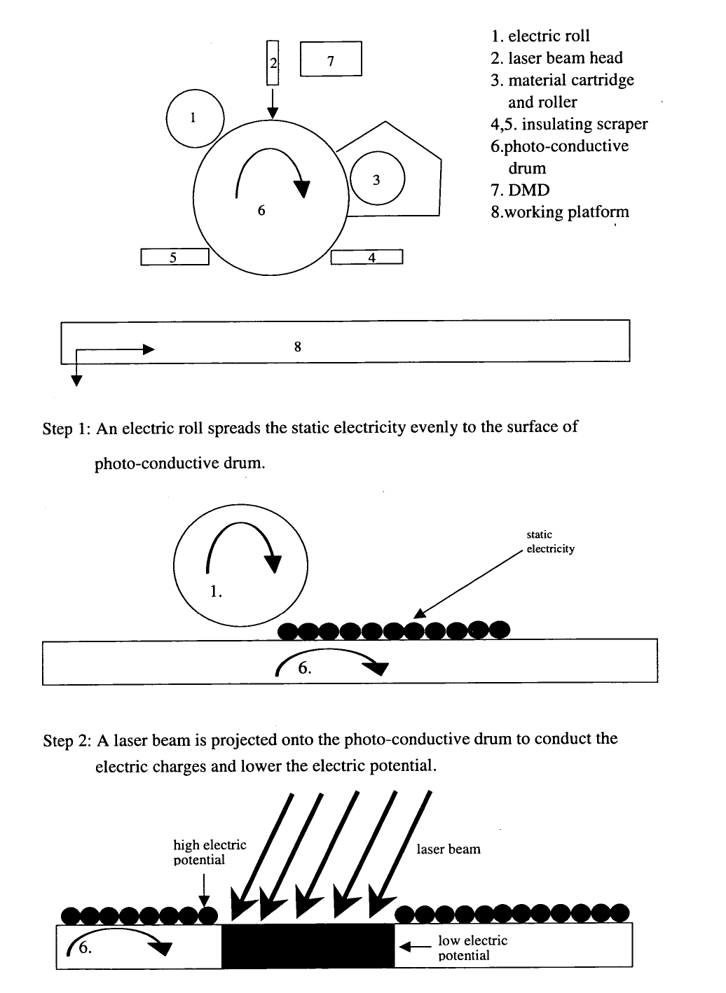

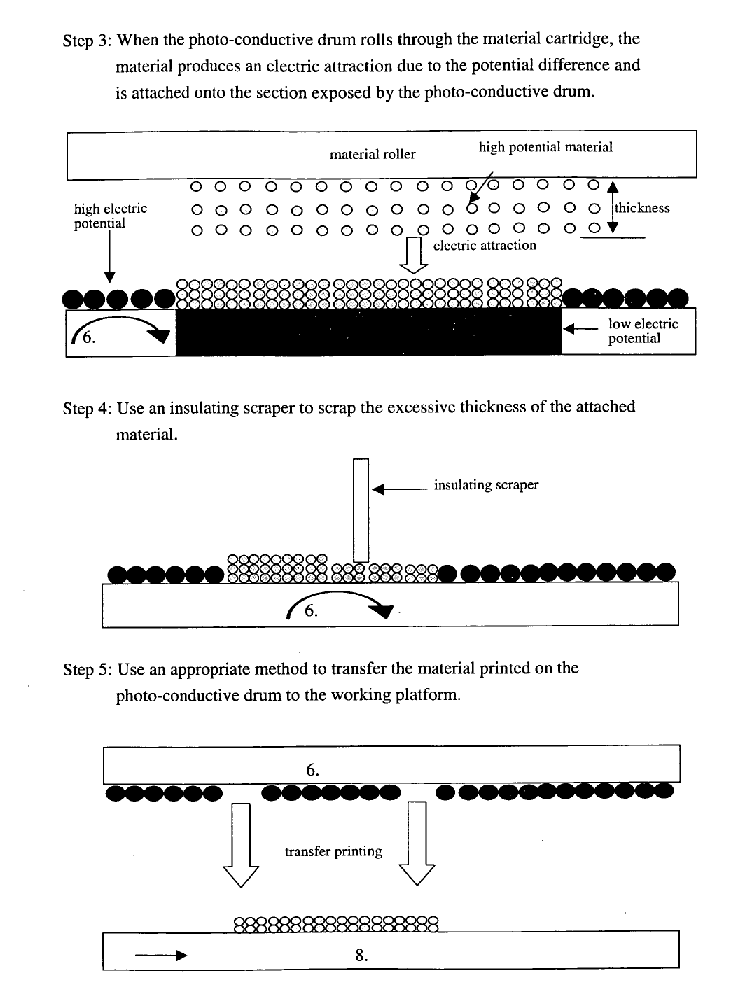

Referring to FIG. 19 for the method of manufacturing rapid prototyping workpiece according to a tenth preferred embodiment of the present invention, the basic manufacturing procedure comprises the following steps:
Step 1: An electric roll spreads the static electricity evenly to the surface of photo-conductive drum.
Step 2: A visible light is projected onto the photo-conductive drum to conduct its electric charges and lower its electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: A selective point light source of stronger intensity is used for scanning and projecting the selected region to produce a physical change or a chemical change to combine the materials with each other to produce an acceptable property.
Step 7: The materials remained on the photo-conductive drum are removed and the electric charges on the photo-conductive drum are eliminated.
Step 8: Repeat Steps 1 to 7 until the physical object is formed.

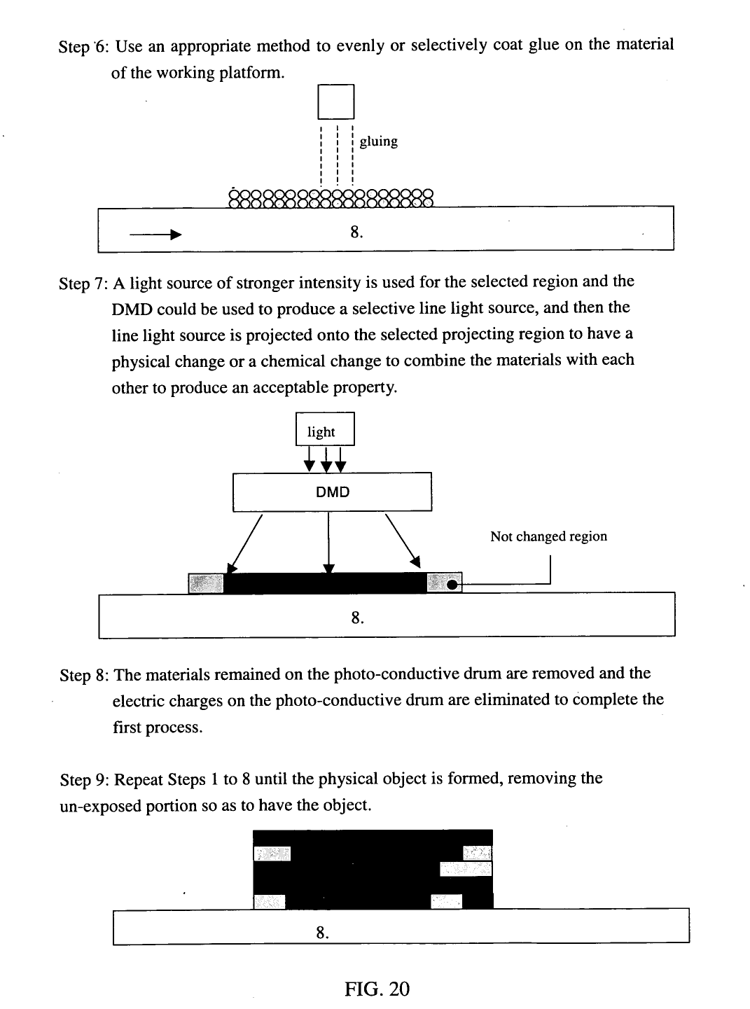

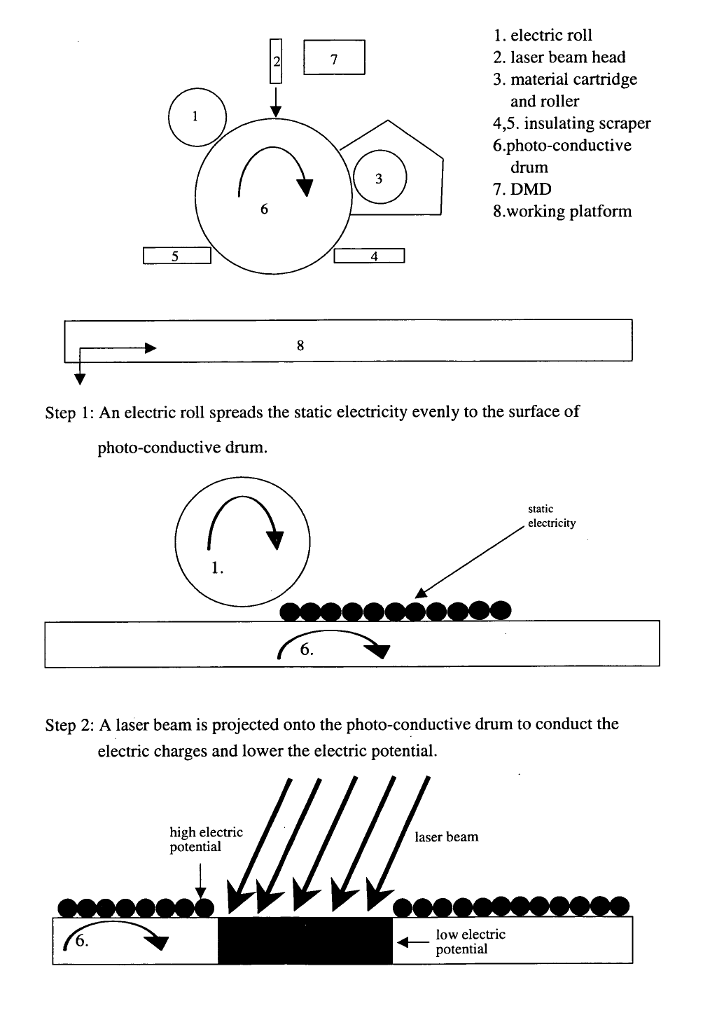

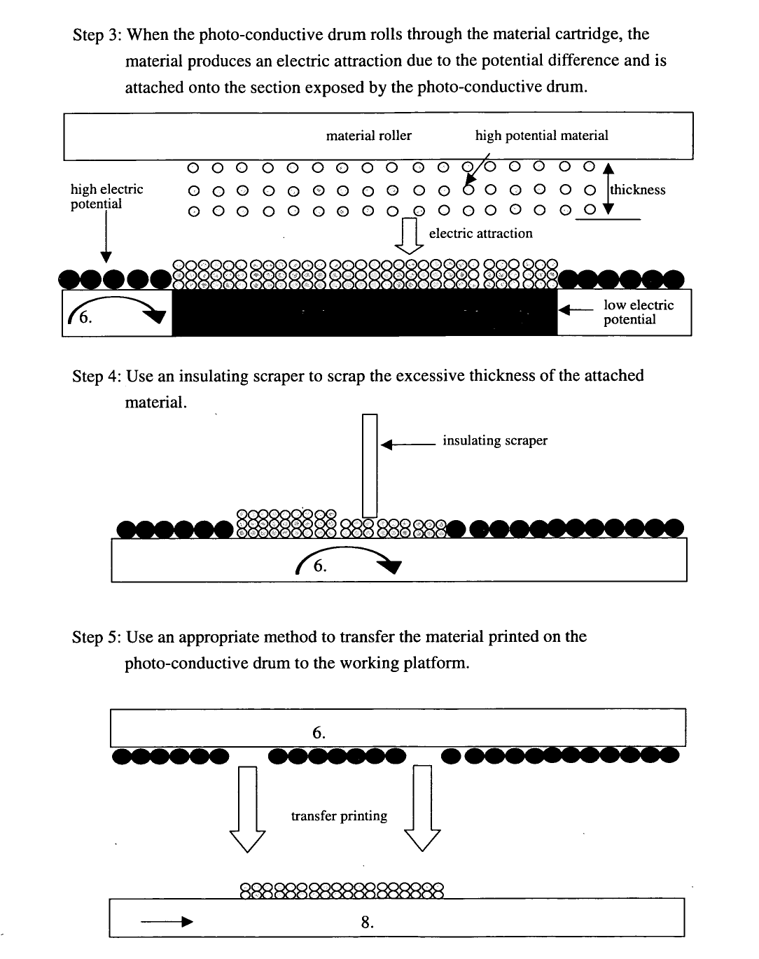

Referring to FIG. 20 for the method of manufacturing rapid prototyping workpiece according to an eleventh preferred embodiment of the present invention, the basic manufacturing procedure comprises the following steps:
Step 1: An electric roll spreads the static electricity evenly to the surface of photo-conductive drum.
Step 2: A laser beam is projected onto the photo-conductive drum to conduct its electric charges and lower its electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: Use an appropriate method to evenly or selectively coat glue on the material of the working platform.
Step 7: A light source of stronger intensity is used for the selected region and DMD could be used to produce a selective line light source, and then the line light source is projected onto the selected projecting region to have a physical change or a chemical change to combine the materials with each other to produce an acceptable property.
Step 8: The materials remained on the photo-conductive drum are removed and the electric charges on the photo-conductive drum are eliminated.
Step 9: Repeat Steps 1 to 8 until a physical object is formed.

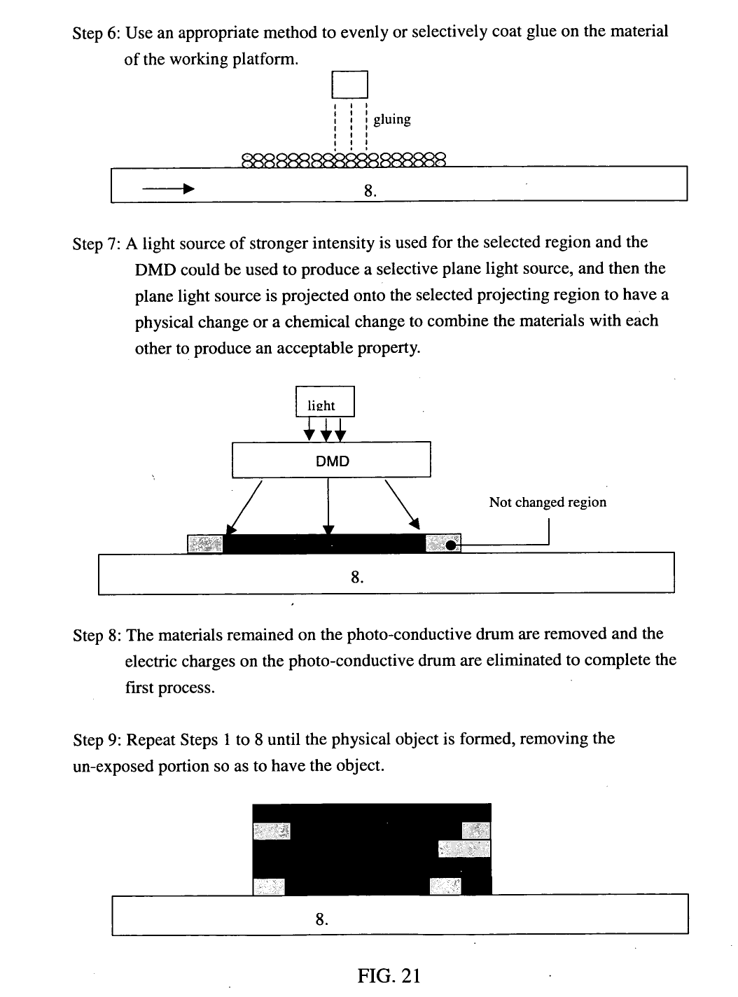

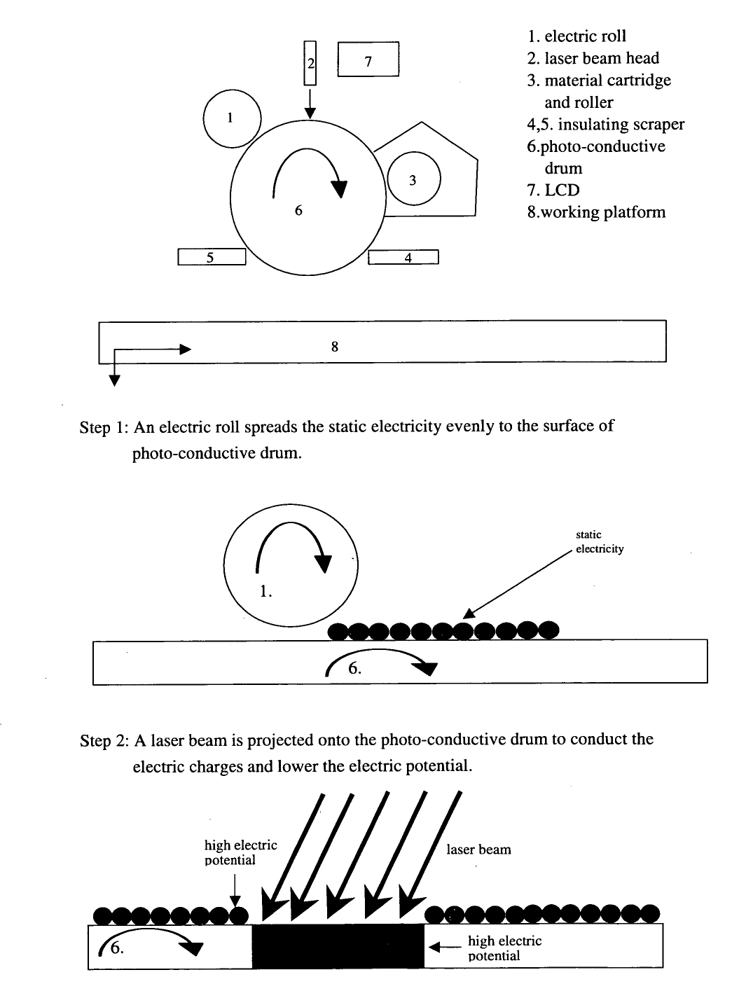

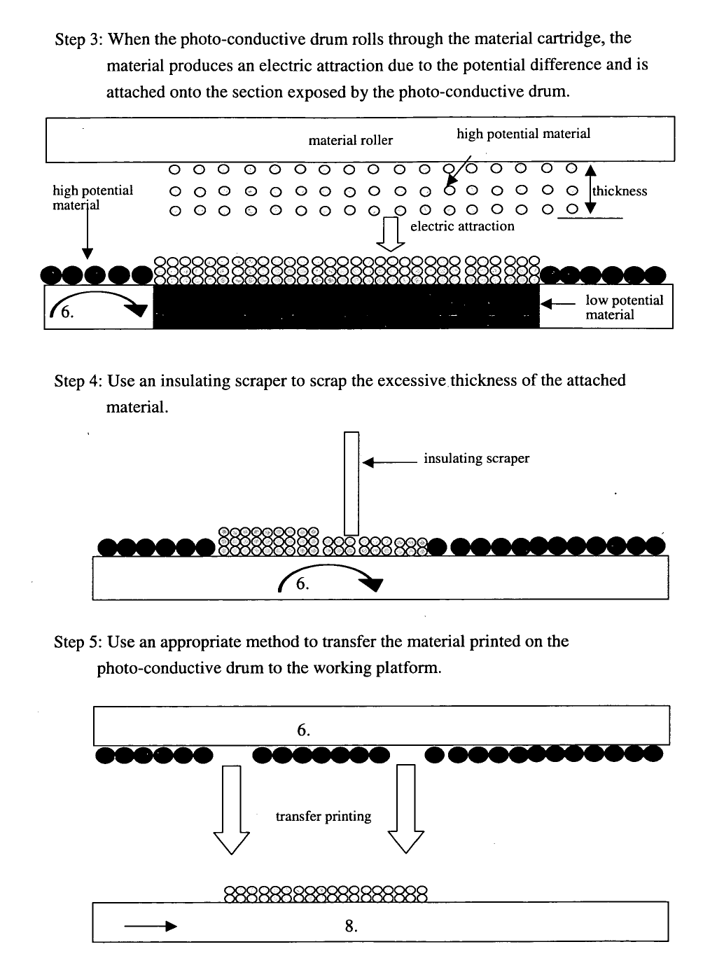

Referring to FIG. 21 for the method of manufacturing rapid prototyping workpiece according to a twelfth preferred embodiment of the present invention, the basic manufacturing procedure comprises the following steps:
Step 1: An electric roll spreads the static electricity evenly to the surface of photo-conductive drum.
Step 2: A laser beam is projected onto the photo-conductive drum to conduct the electric charges and lower the electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: Use an appropriate method to evenly or selectively coat glue on the material of the working platform.
Step 7: A light source of stronger intensity is used for the selected region and DMD could be used to produce a selective plane light source, and then the plane light source is projected onto the selected projecting region to have a physical change or a chemical change to combine the materials with each other to produce an acceptable property.
Step 8: The materials remained on the photo-conductive drum are removed and the electric charges on the photo-conductive drum are eliminated.
Step 9: Repeat Steps 1 to 8 until a physical object is formed.

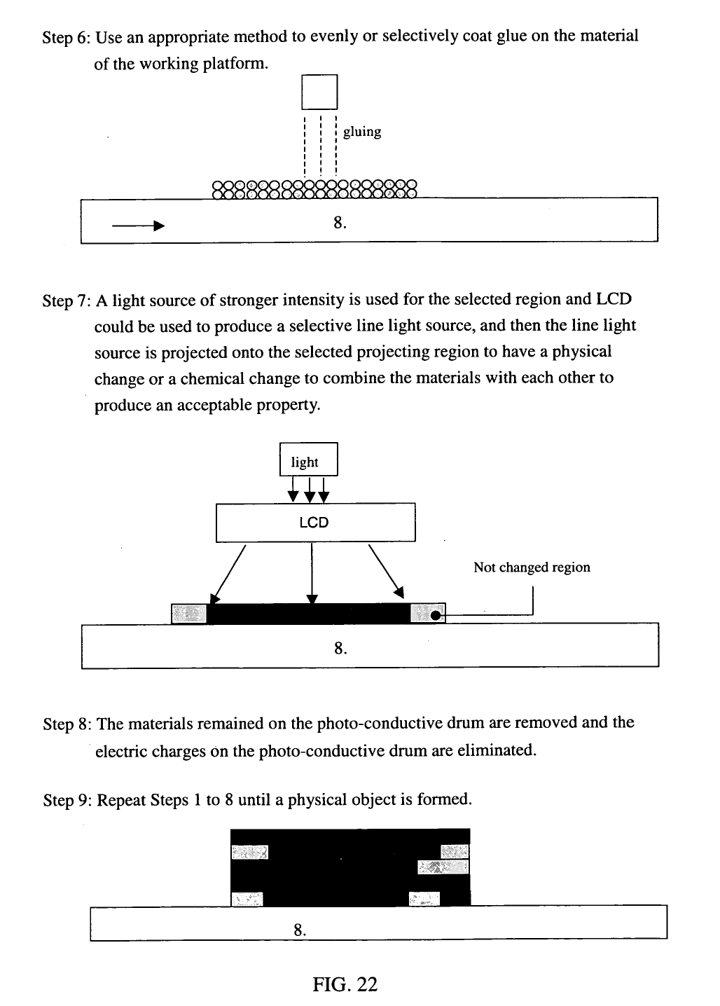

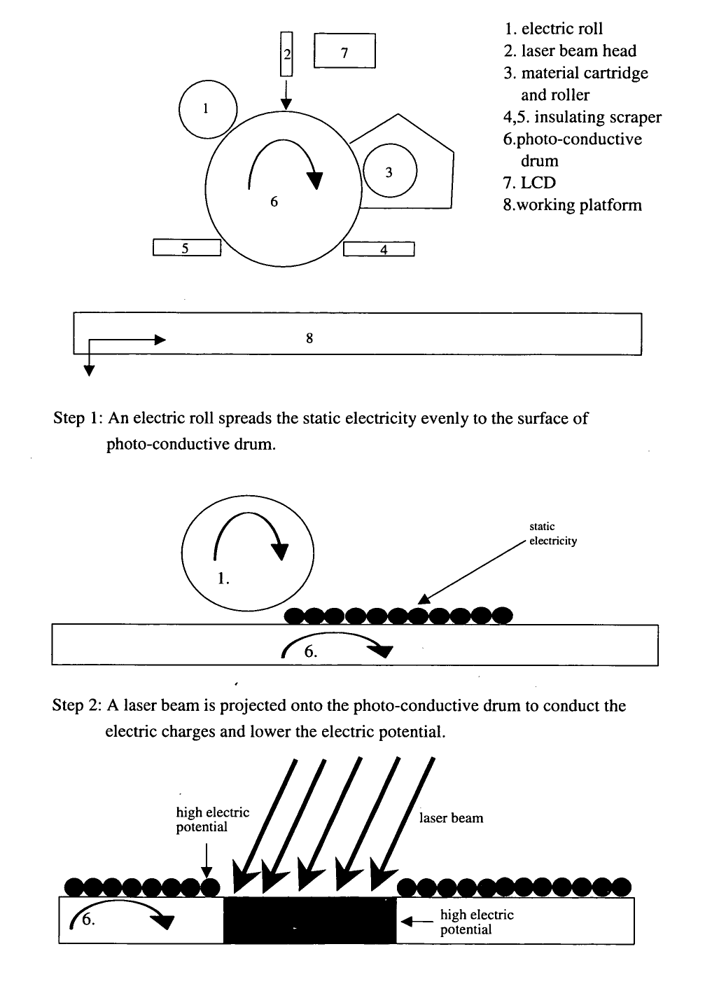

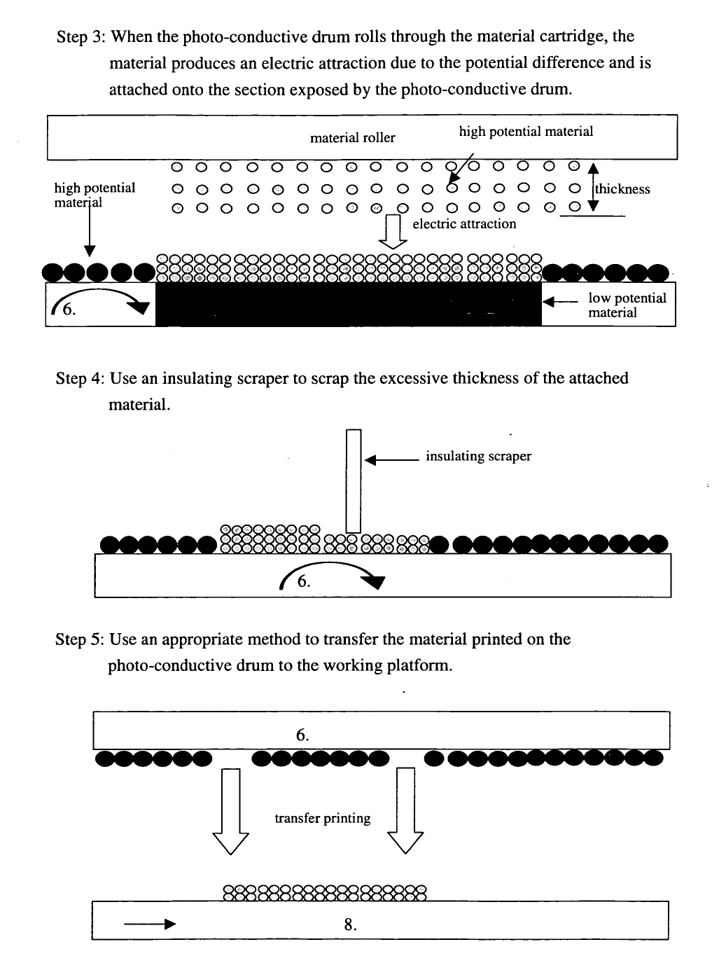

Referring to FIG. 22 for the method of manufacturing rapid prototyping workpiece according to a thirteenth preferred embodiment of the present invention, the basic manufacturing procedure comprises the following steps:
Step 1: An electric roll spreads the static electricity evenly to the surface of photo-conductive drum.
Step 2: A laser beam is projected onto the photo-conductive drum to conduct the electric charges and lower the electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: Use an appropriate method to evenly or selectively coat glue on the material of the working platform.
Step 7: A light source of stronger intensity is used for the selected region and LCD could be used to produce a selective line light source, and then the line light source is projected onto the selected projecting region to have a physical change or a chemical change to combine the materials with each other to produce an acceptable property.
Step 8: The materials remained on the photo-conductive drum are removed and the electric charges on the photo-conductive drum are eliminated.
Step 9: Repeat Steps 1 to 8 until a physical object is formed.

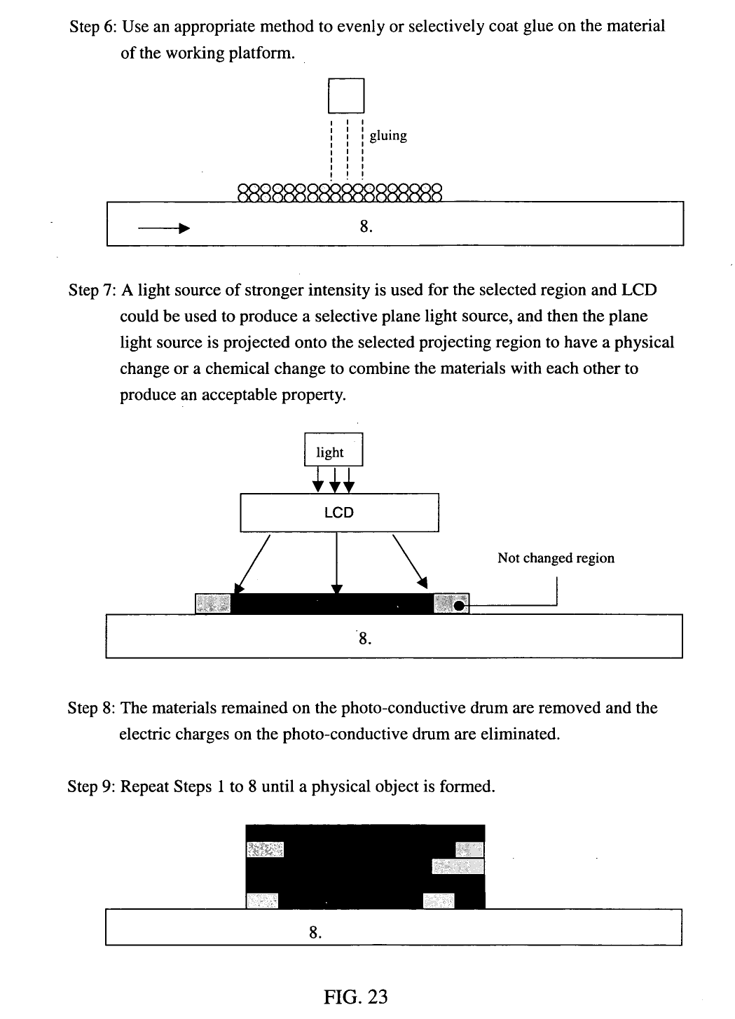

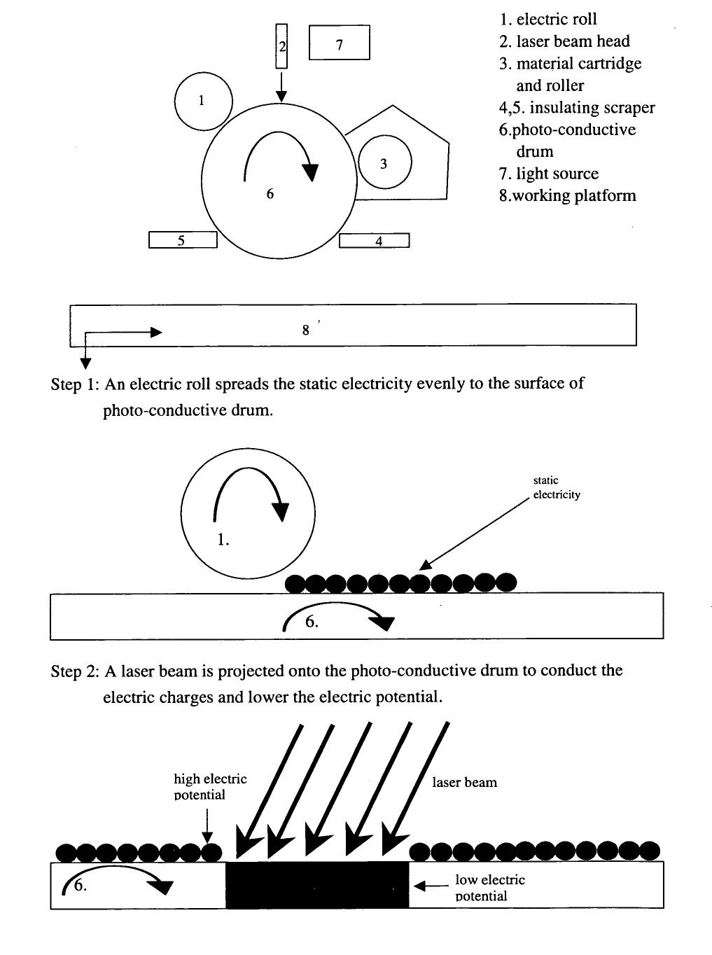

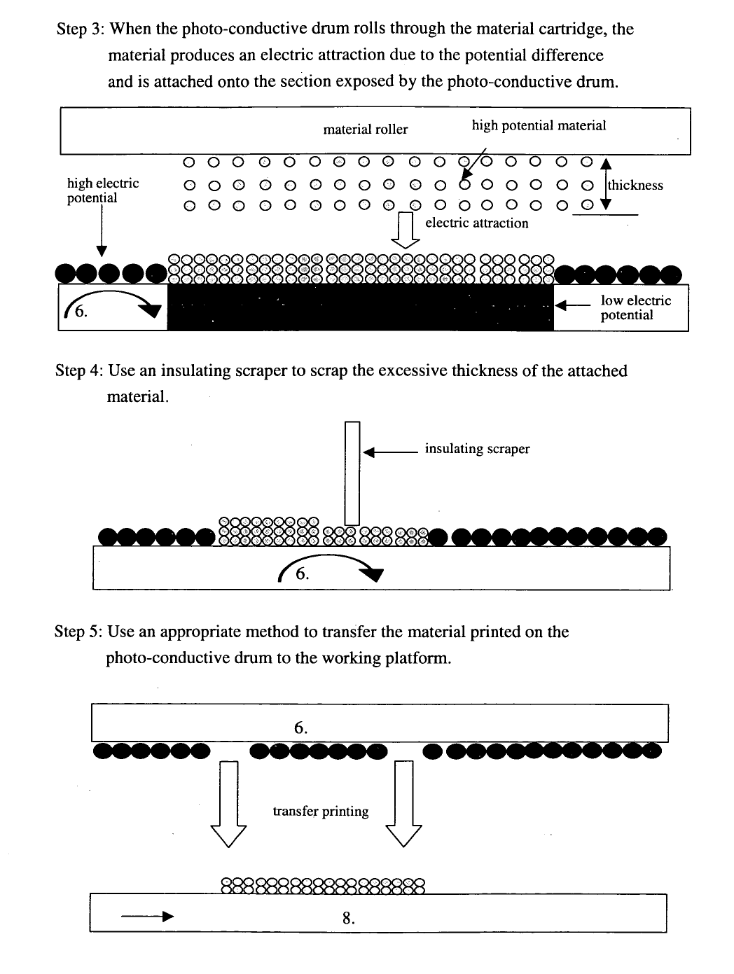

Referring to FIG. 23 for the method of manufacturing rapid prototyping workpiece according to a fourteenth preferred embodiment of the present invention, the basic manufacturing procedure comprises the following steps:
Step 1: An electric roll spreads the static electricity evenly to the surface of photo-conductive drum.
Step 2: A laser beam is projected onto the photo-conductive drum to conduct the electric charges and lower the electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: Use an appropriate method to evenly or selectively coat glue on the material of the working platform.
Step 7: A light source of stronger intensity is used for the selected region and LCD could be used to produce a selective plane light source, and then the plane light source is projected onto the selected projecting region to have a physical change or a chemical change to combine the materials with each other to produce an acceptable property.
Step 8: The materials remained on the photo-conductive drum are removed and the electric charges on the photo-conductive drum are eliminated.
Step 9: Repeat Steps 1 to 8 until a physical object is formed.

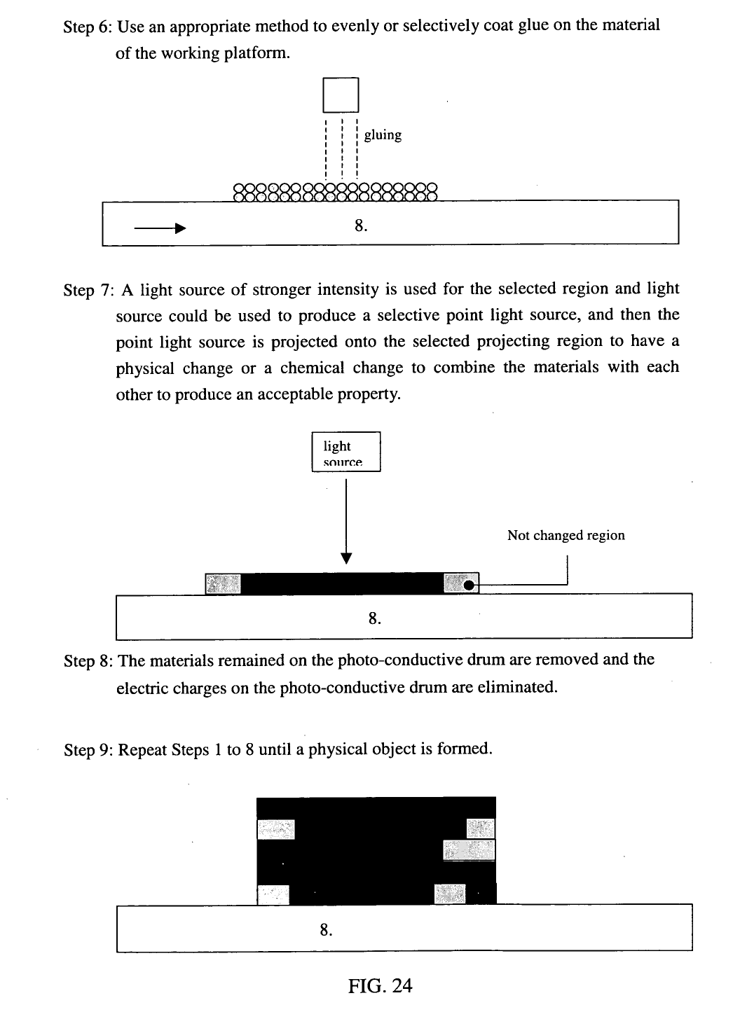

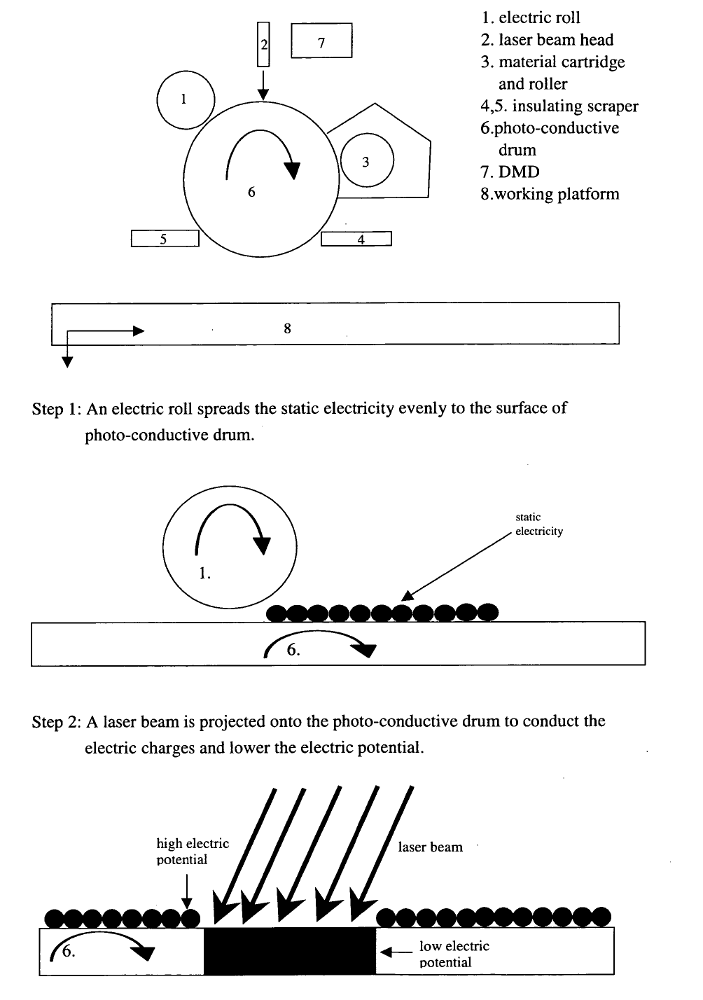

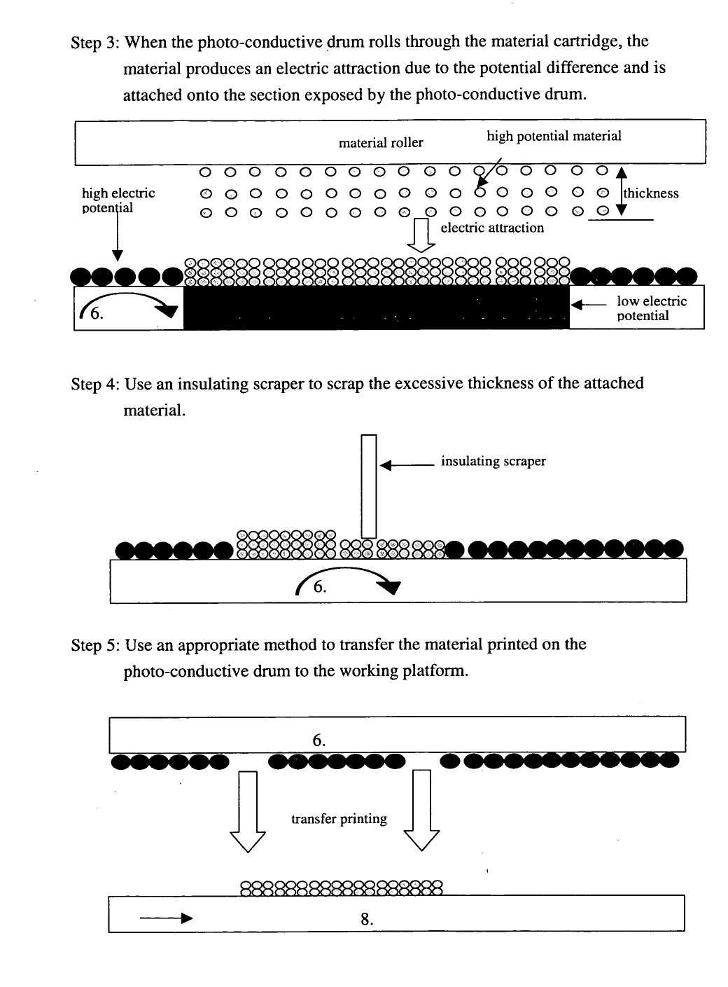

Referring to FIG. 24 for the method of manufacturing rapid prototyping workpiece according to a fifteenth preferred embodiment of the present invention, the basic manufacturing procedure comprises the following steps:
Step 1: An electric roll spreads the static electricity evenly to the surface of photo-conductive drum.
Step 2: A laser beam is projected onto the photo-conductive drum to conduct the electric charges and lower the electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: Use an appropriate method to evenly or selectively coat glue on the material of the working platform.
Step 7: A selective point light source of stronger intensity is used for scanning and projecting the selected region to have a physical change or a chemical change to combine the materials with each other to produce an acceptable property.
Step 8: The materials remained on the photo-conductive drum are removed and the electric charges on the photo-conductive drum are eliminated.
Step 9: Repeat Steps 1 to 8 until a physical object is formed.

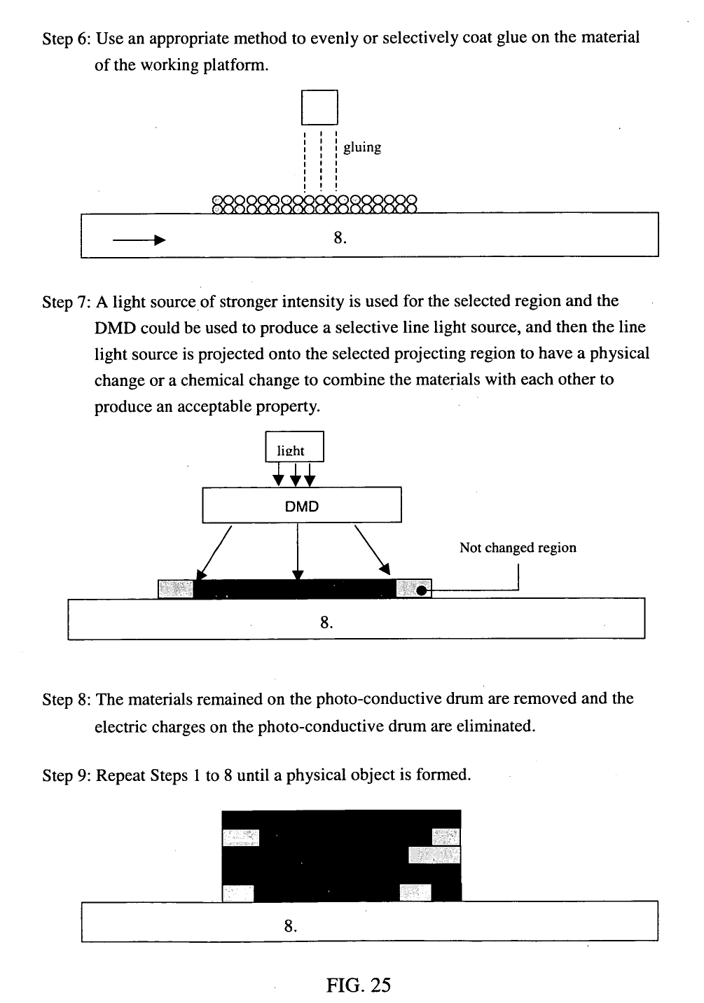

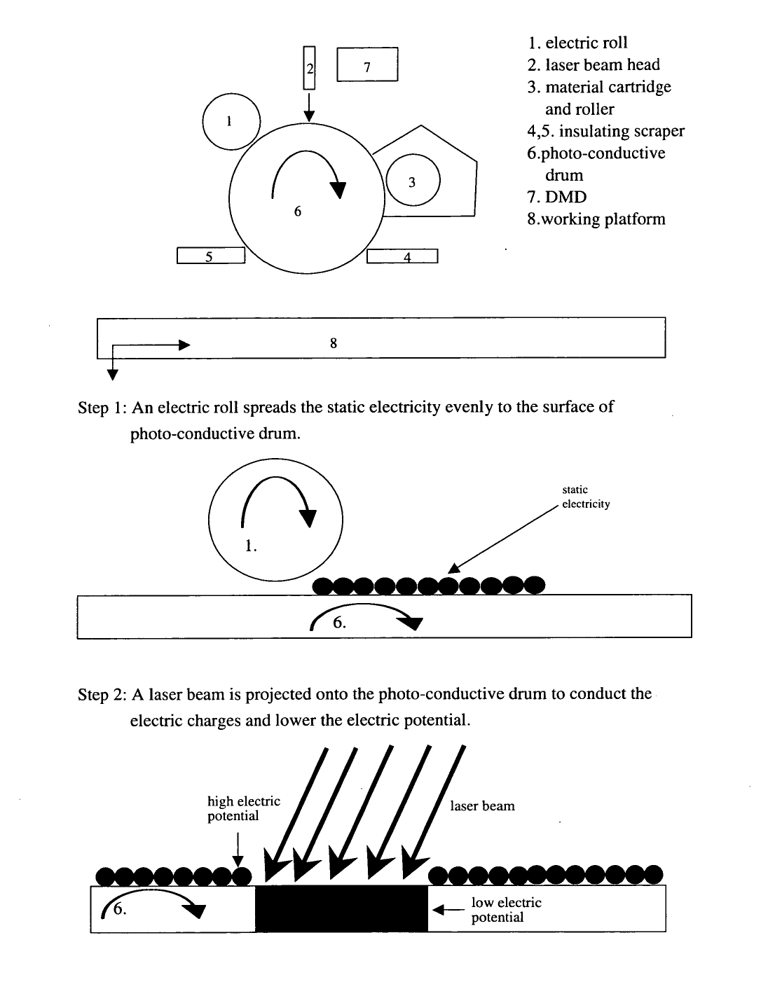

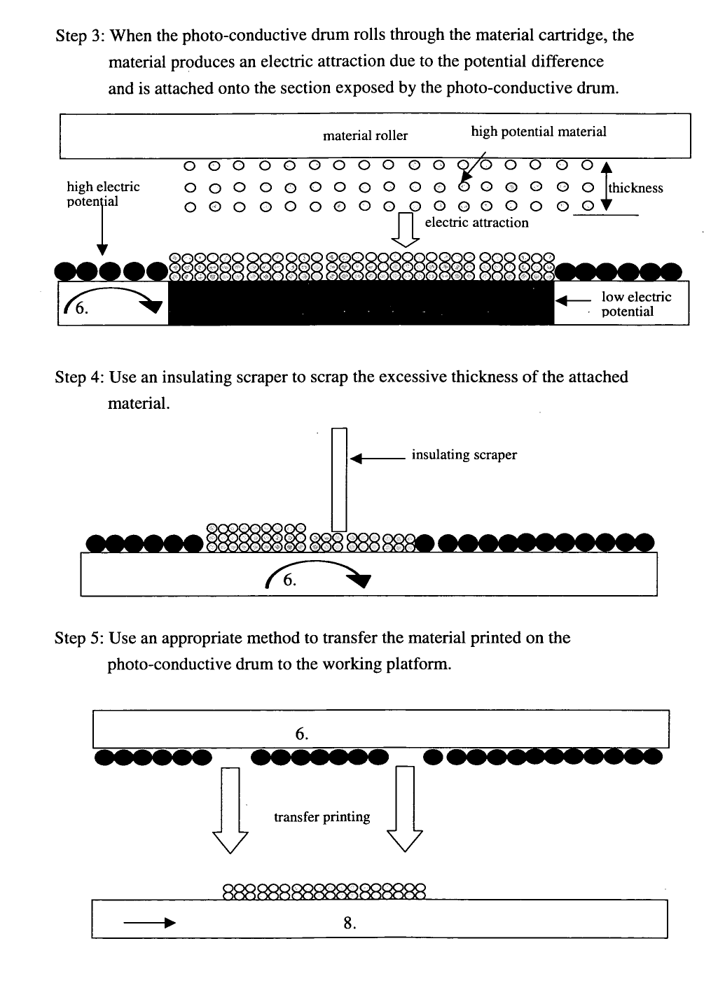

Referring to FIG. 25 for the method of manufacturing rapid prototyping workpiece according to a sixteenth preferred embodiment of the present invention, the basic manufacturing procedure comprises the following steps:
Step 1: An electric roll spreads the static electricity evenly to the surface of photo-conductive drum.
Step 2: A visible light is projected onto the photo-conductive drum to conduct the electric charges and lower the electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: Use an appropriate method to evenly or selectively coat glue on the material of the working platform.
Step 7: A light source of stronger intensity is used for the selected region and DMD could be used to produce a selective line light source, and then the line light source is projected onto the selected projecting region to have a physical change or a chemical change to combine the materials with each other to produce an acceptable property.
Step 8: The materials remained on the photo-conductive drum are removed and the electric charges on the photo-conductive drum are eliminated.
Step 9: Repeat Steps 1 to 8 until a physical object is formed.

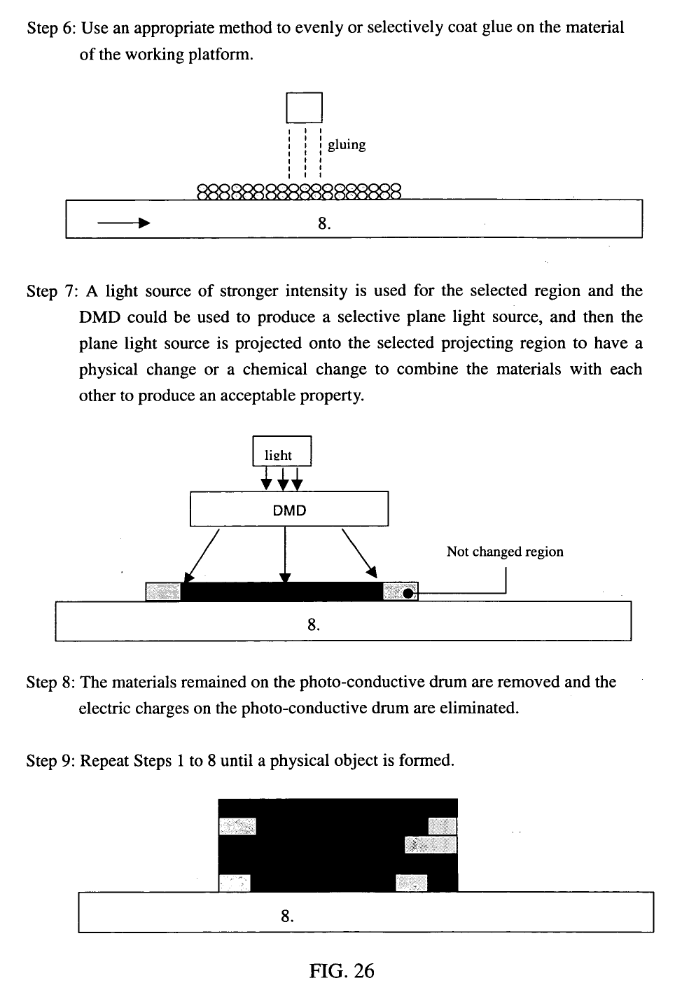

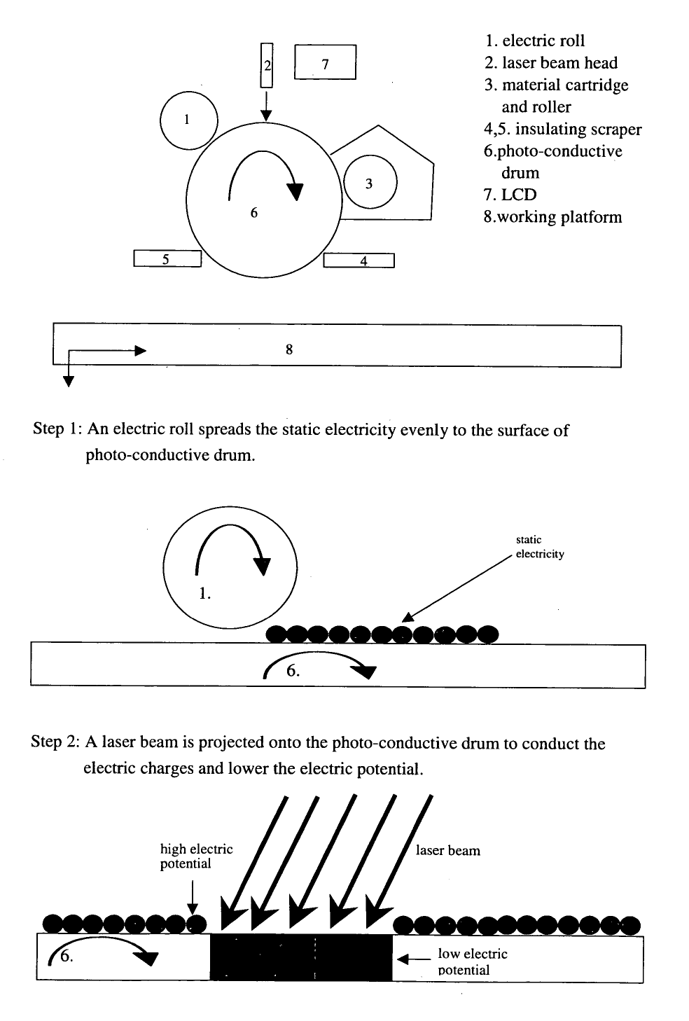

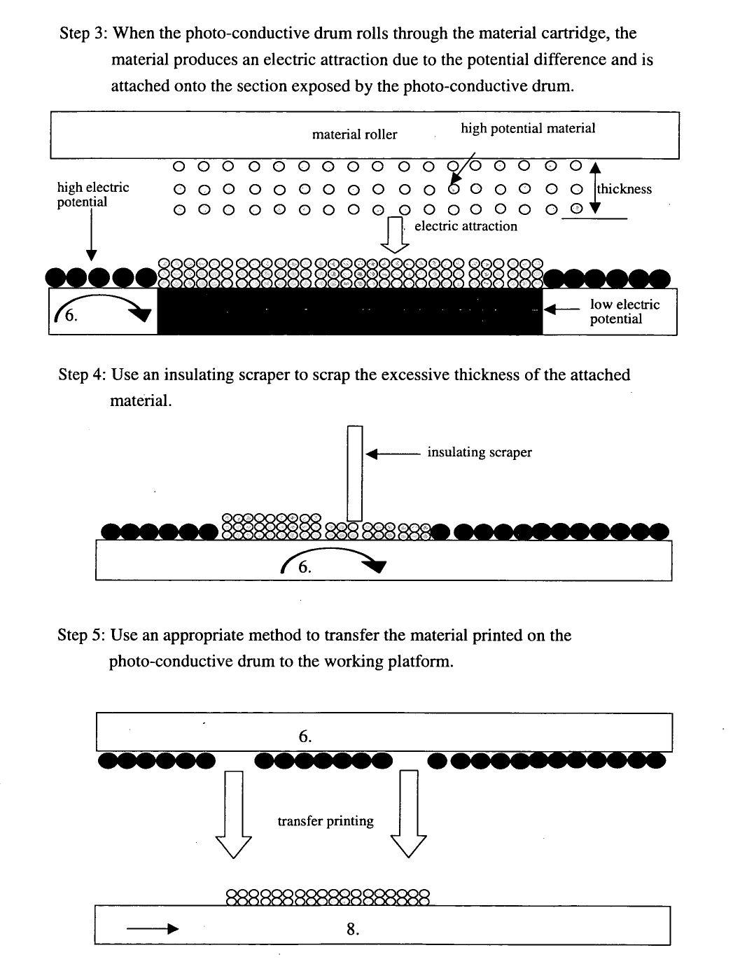

Referring to FIG. 26 for the method of manufacturing rapid prototyping workpiece according to a seventeenth preferred embodiment of the present invention, the basic manufacturing procedure comprises the following steps:
Step 1: An electric roll spreads the static electricity evenly to the surface of photo-conductive drum.
Step 2: A visible light is projected onto the photo-conductive drum to conduct its electric charges and lower its electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: Use an appropriate method to evenly or selectively coat glue on the material of the working platform.
Step 7: A light source of stronger intensity is used for the selected region and DMD could be used to produce a selective plane light source, and then the plane light source is projected onto the selected projecting region to have a physical change or a chemical change to combine the materials with each other to produce an acceptable property.
Step 8: The materials remained on the photo-conductive drum are removed and the electric charges on the photo-conductive drum are eliminated.
Step 9: Repeat Steps 1 to 8 until a physical object is formed.

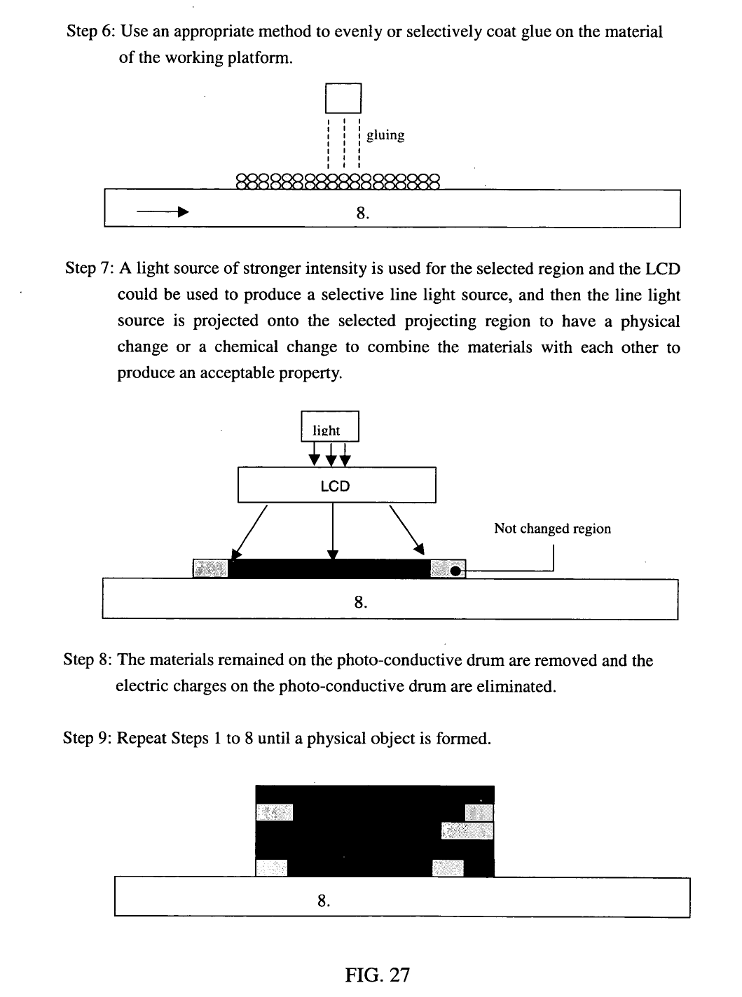

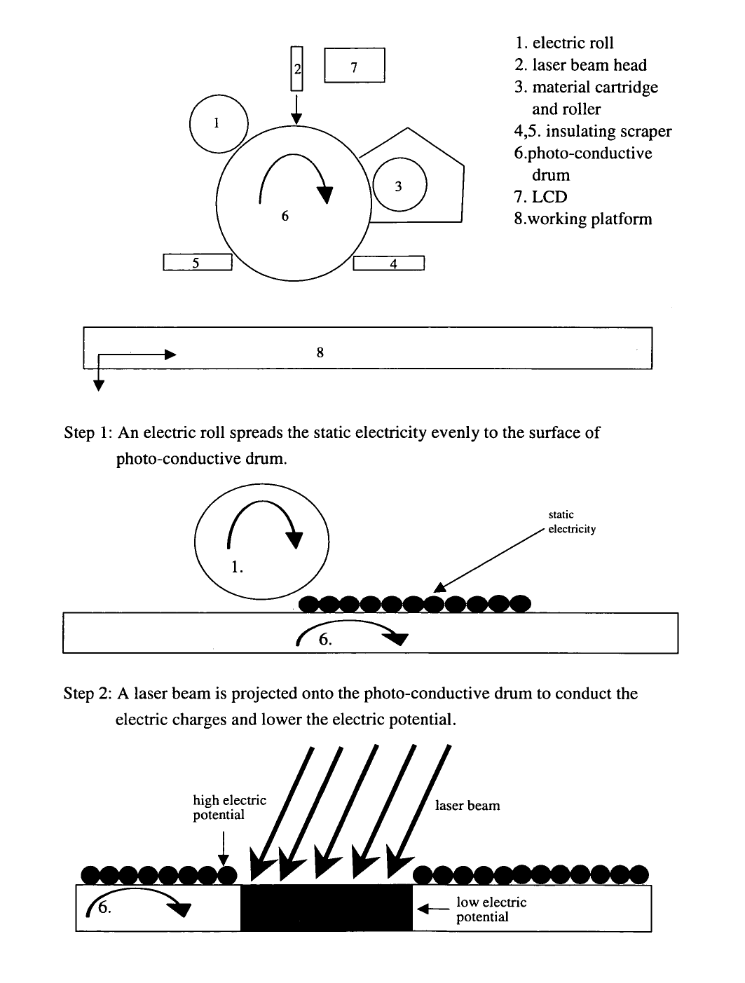

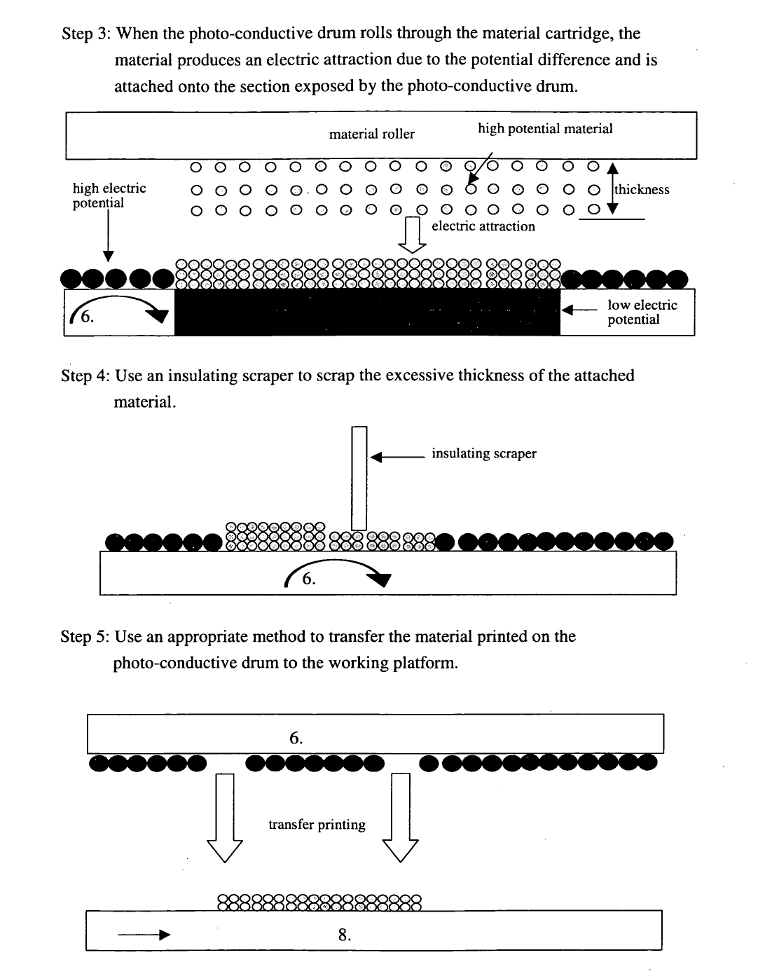

Referring to FIG. 27 for the method of manufacturing rapid prototyping workpiece according to an eighteenth preferred embodiment of the present invention, the basic manufacturing procedure comprises the following steps:
Step 1: An electric roll spreads the static electricity evenly to the surface of photo-conductive drum.
Step 2: A visible light is projected onto the photo-conductive drum to conduct its electric charges and lower its electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: Use an appropriate method to evenly or selectively coat glue on the material of the working platform.
Step 7: A light source of stronger intensity is used for the selected region and LCD could be used to produce a selective line light source, and then the line light source is projected onto the selected projecting region to have a physical change or a chemical change to combine the materials with each other to produce an acceptable property.
Step 8: The materials remained on the photo-conductive drum are removed and the electric charges on the photo-conductive drum are eliminated.
Step 9: Repeat Steps 1 to 8 until a physical object is formed.

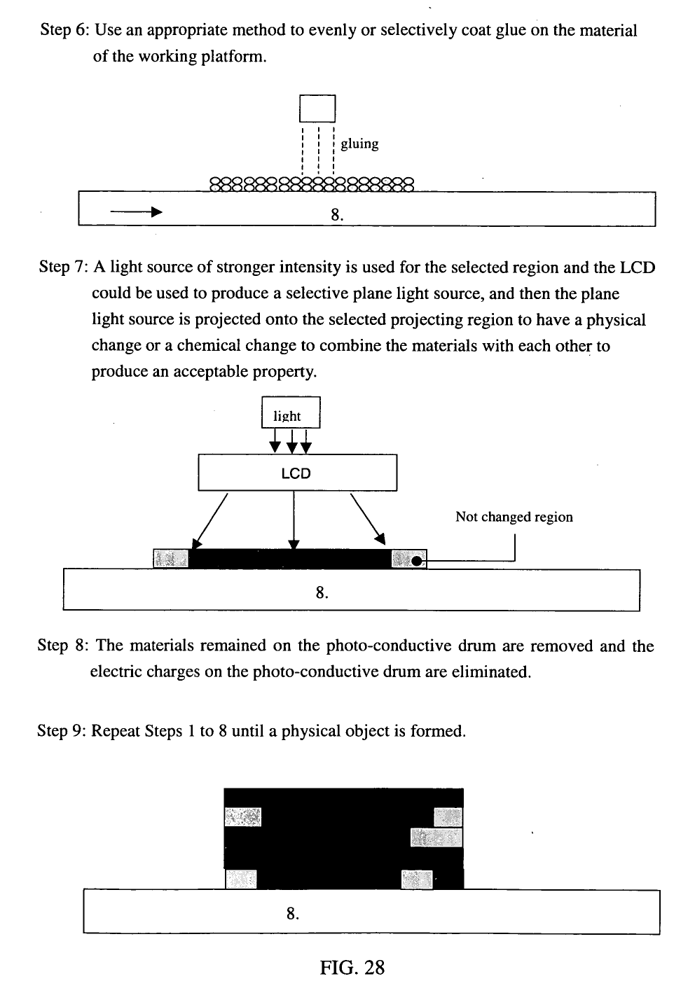

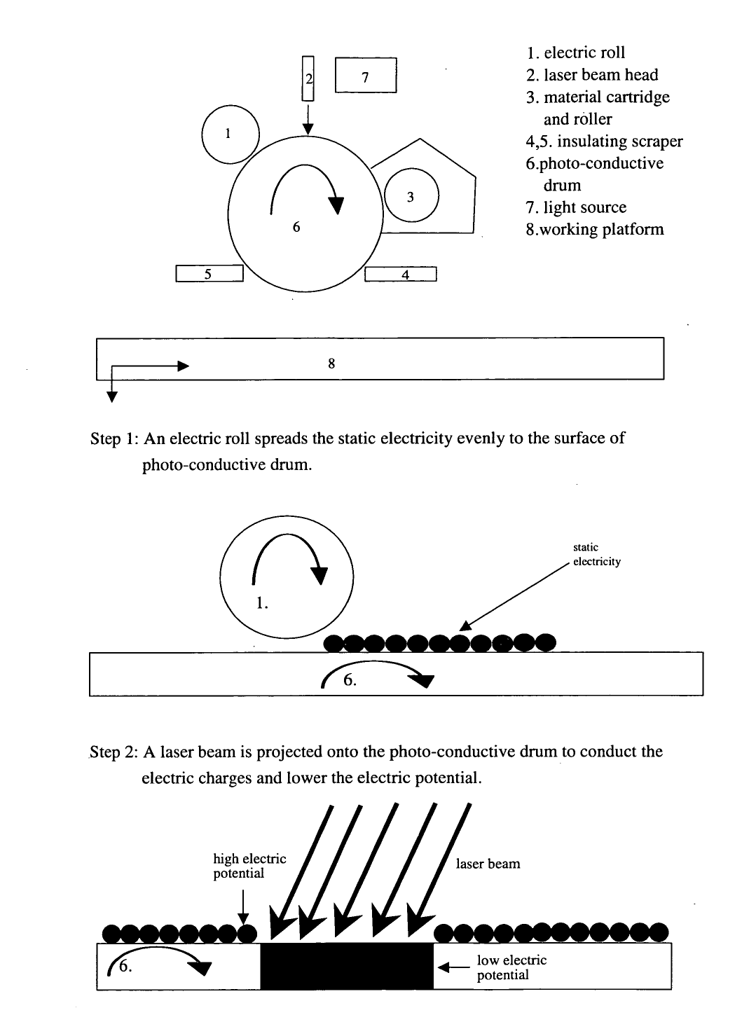

Referring to FIG. 28 for the method of manufacturing rapid prototyping workpiece according to a nineteenth preferred embodiment of the present invention, the basic manufacturing procedure comprises the following steps:
Step 1: An electric roll spreads the static electricity evenly to the surface of photo-conductive drum.
Step 2: A visible light is projected onto the photo-conductive drum to conduct its electric charges and lower its electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: Use an appropriate method to evenly or selectively coat glue on the material of the working platform.
Step 7: A light source of stronger intensity is used for the selected region and LCD could be used to produce a selective plane light source, and then the plane light source is projected onto the selected projecting region to have a physical change or a chemical change to combine the materials with each other to produce an acceptable property.
Step 8: The materials remained on the photo-conductive drum are removed and the electric charges on the photo-conductive drum are eliminated.
Step 9: Repeat Steps 1 to 8 until a physical object is formed.

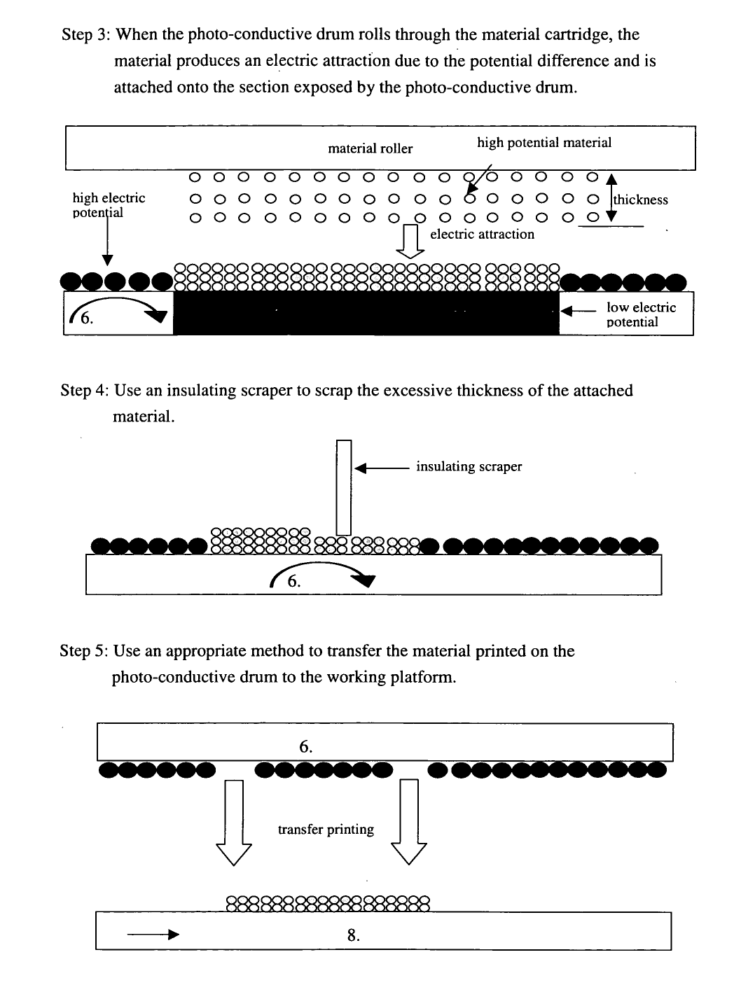

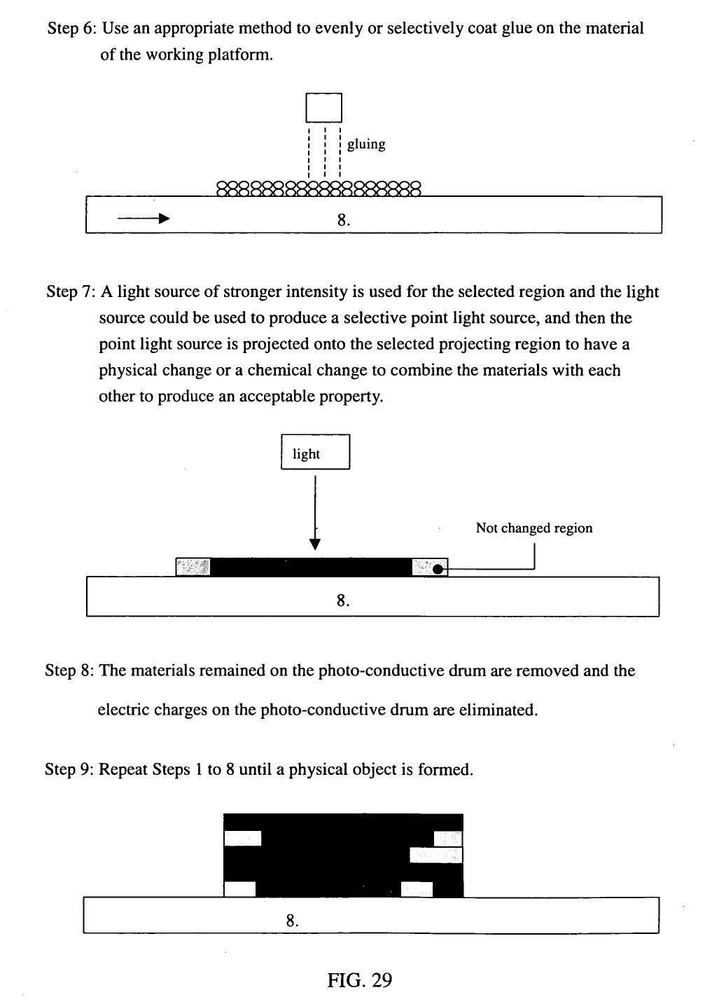

Referring to FIG. 29 for the method of manufacturing rapid prototyping workpiece according to a twentieth preferred embodiment of the present invention, the basic manufacturing procedure comprises the following steps:
Step 1: An electric roll spreads the static electricity evenly to the surface of photo-conductive drum.
Step 2: A visible light is projected onto the photo-conductive drum to conduct its electric charges and lower its electric potential.
Step 3: When the photo-conductive drum rolls through the material cartridge, the material produces an electric attraction due to the potential difference and is attached onto the section exposed by the photo-conductive drum.
Step 4: Use an insulating scraper to scrap the excessive thickness of the attached material.
Step 5: Use an appropriate method to transfer the material printed on the photo-conductive drum to the working platform.
Step 6: Use an appropriate method to evenly or selectively coat glue on the material of the working platform.
Step 7: A selective point light source of stronger intensity is used for scanning and projecting the selected region to have a physical change or a chemical change to combine the materials with each other to produce an acceptable property.
Step 8: The materials remained on the photo-conductive drum are removed and the electric charges on the photo-conductive drum are eliminated.
Step 9: Repeat Steps 1 to 8 until a physical object is formed.

Since the physical and chemical properties of the material are different before or after being projected by a light, the unchanged material surrounds the periphery of the stronger material as a support during the manufacturing process of the present invention. An appropriate method can be used to separate the two different materials after the workpiece is produced, so as to rapidly finish the manufacture of a three-dimensional physical workpiece, and thus achieving the objectives of saving manufacturing time, materials and costs as well as improving precision.

In summation of the above description, the present invention herein complies with the patent application requirements and is submitted for patent application. However, the description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of manufacturing rapid prototyping workpiece by using laser transfer printing technology, having an operating principle of using a computer assisted design to divide a three-dimensional figure into two dimensional areas, and forming said each two-dimensional area layer by layer, and stacking said two-dimensional areas into a three-dimensional physical object, and said method comprising the following steps:
Step 1: An electric roll spreads static electricity evenly to the surface of a photo-conductive drum;
Step 2: A laser beam is projected onto said photo-conductive drum to electrically conduct its electric charges and lower its electric potential;
Step 3: Said photo-conductive drum attaches a powder material when passing a material cartridge, since there exists a potential difference to produce an electric attraction to attach said powder material onto an exposed section of said photo-conductive drum;
Step 4: An insulating scraper is used to scrap excessive thickness of said attached material;
Step 5: An appropriate method is used to apply pressure, heat or electric potential to transfer printing said material disposed on said photo-conductive drum to a working platform;
Step 6. A light source of stronger intensity is used for a selected region and goes with a DMD to produce a selective line light source, and said line light source is projected on said selected region to produce a physical or chemical change to combine said material into an acceptable property;
Step 7: Said materials remained on the photo-conductive drum are removed and said electric charges on the photo-conductive drum are eliminated; and
Step 8: Repeat Steps 1 to 7 until the physical object is formed.

2. The method of manufacturing rapid prototyping workpiece by using laser transfer printing technology of claim 1, wherein said method projects a visible light to electric conduct electric charges on said photo-conductive drum and lower its electric potential.

3. The method of manufacturing rapid prototyping workpiece by using laser transfer printing technology of claim 1, wherein said Step 3 uses a strong light to go with a DMD to produce a selective plane light source, and then project said plane light source onto said selected region to produce a physical or chemical change, so as to combine said materials to produce an acceptable property.

4. The method of manufacturing rapid prototyping workpiece by using laser transfer printing technology of claim 1, wherein said Step 3 uses a strong light to go with an LCD to produce a selective line light source, and then project said line light source onto said selected region to produce a physical or chemical change, so as to combine said materials to produce an acceptable property.

5. The method of manufacturing rapid prototyping workpiece by using laser transfer printing technology of claim 1, wherein said Step 3 uses a strong light to go with an LCD to produce a selective plane light source, and then project said plane light source onto said selected region to produce a physical or chemical change, so as to combine said materials to produce an acceptable property.

6. The method of manufacturing rapid prototyping workpiece by using laser transfer printing technology of claim 1, wherein said Step 6 uses an appropriate method to evenly apply glue or selectively cover said material of said working platform instead, and the original Steps 6, 7 and 8 become Step 7, 8 and 9 correspondingly.

7. The method of manufacturing rapid prototyping workpiece by using laser transfer printing technology of claim 1, wherein said Step 6 uses a point light source of stronger intensity to scan and project said selected region to produce a physical or chemical change, so as to combine said materials into an acceptable property.

8. The method of manufacturing rapid prototyping workpiece by using laser transfer printing technology of claim 3, wherein said manufacturing process uses one or more photo-conductive drums, and the quantity of said photo-conductive drum is not limited.

9. The method of manufacturing rapid prototyping workpiece by using laser transfer printing technology of claim 8, wherein said manufacturing process uses one or more plane photo-conductive drums.
